(19) United States
(12) Patent Application Publication
(10) Pub. No.: US 2017/0140370 A1
(43) Pub. Date: May 18, 2017

(54) MANAGEMENT DEVICE, MANAGEMENT METHOD, AND PROGRAM

(71) Applicants: RAKUTEN, INC., Tokyo (JP); RAKUTEN EDY, INC., Tokyo (JP)

(72) Inventor: Wataru SUZUKAKE, Tokyo (JP)

(73) Assignee: Rakuten, Inc., Tokyo (JP)

(21) Appl. No.: 15/039,218

(22) PCT Filed: Nov. 26, 2013
(86) PCT No.: PCT/JP2013/081799

§ 371 Date: Jan. 18, 2017

(51) Int. Cl. G06Q 20/36; G06Q 20/32; G06Q 50/06

(52) U.S. Cl. CPC G06Q 20/3678; G06Q 50/06; G06Q 20/327

(57) ABSTRACT

A trade management device transmits, to a portable device, a request of decreasing a minimum price corresponding to the minimum trade unit of the trade object from a remaining value associated with the portable device. A controller provides the trade object by the minimum trade unit when a response to the request from the portable device indicates that the request is successful. A determiner determines whether the next providing of the trade object is possible on the basis of the providing status of the trade object. When a determination that the next providing is possible is made, the next request of further decreasing the minimum price is transmitted to the portable device. When a determination that the next providing is not ready is made, the trade is ended without a transmission of the next request.

### TECHNICAL FIELD

The present disclosure relates to a management device and a management method that manage trades by electronic money, and a program for accomplishing those by a computer.

### BACKGROUND ART

Various systems have been proposed which utilize electronic money in trades for getting provided products and services by paying a compensation. According to electronic money systems, instead of causing a user to put cashes in a wallet and to carry this wallet, a payment is made by a value (equivalent to the cashes in the wallet) associated with a portable device (equivalent to the wallet) and expressed by electronic information.

According to trades by electronic money, a configuration is widely applied in which at the time of billing, a portable device is once held over a provider's reader/writer for a short time, and the remaining value associated with the portable device is decreased, thereby paying the value. Patent Literature 1 discloses a technology of an electronic money server for a periodical fee payment by electronic money.

Conversely, there are also trades that, at the time of the beginning thereof, how much products or services should be provided is unknown, and the total provided quantity will become apparent after the completion of the product or service providing. Examples of such a trade are an unattended copy service that utilizes an Auto Document Feeder (ADF), and a purchase of gasoline by a self-service fuel providing machine up to the fill-up of the tank at a gas station.

According to such an unattended service and unattended sales, in order to prevent a person who has received the product or the service from leaving without a payment of the compensation, a scheme of, for example, causing the person to load several amounts of money by cash prior to the start of the providing, and returning changes after the completion of the providing, or causing the user to load a credit card in a machine prior to the start of the providing so as to prevent the user from leaving, executing a billing process by credit card after the completion of the providing, and returning the credit card are adopted.

Patent Literature 2 discloses a scheme of (paragraph 0004) billing by electronic money every time a copying per a document completes, and a technology of (abstract) causing a user to pay some amounts of money from a payment medium for electronic money prior to the start of the copying, and of writing returned changes in the payment medium in accordance with the actual number of copied documents after the completion of the copying.

### CITATION LIST

### Patent Literature

Patent Literature 1: Unexamined Japanese Patent Application Kokai Publication No. 2013-140452

Patent Literature 2: Unexamined Japanese Patent Application Kokai Publication No. 2009-301244

### SUMMARY OF INVENTION

### Technical Problem

However, according to the configuration in which a payment of the value equivalent to a deposit is made from a portable device prior to the start of the providing, and of returning the value equivalent to changes after the completion of the providing, the portable device should be held over a reader/writer twice at the start of a trade and at the end thereof. As explained above, however, according to stored value type systems, a configuration in which the portable device is held over the reader/writer once at the time of payment of the compensation for a short time is widely applied. Hence, an occasion in which the person subjected to the providing fails to get the returned value may happen.

The present disclosure is to address the foregoing problems, and an objective of the present disclosure is to provide suitable management device and management method for managing trades in which the total provided quantity of a trade object to be provided from the start of the trade and until the end thereof is settled, and the remaining value associated with a portable device is decreased from the start of the trade and until the end thereof as a compensation for the providing by what corresponds to the total price value to the total provided quantity, and a program for accomplishing those by a computer.

### Solution to Problem

According to the present disclosure, using a communicator that communicates with a portable device entering a communicable range, when a trade in which a total provided quantity of a trade object provided from a start of the trade and an end thereof is settled upon the end of the trade is managed:

a request of decreasing a minimum price value corresponding to a minimum trade unit of the trade object from a remaining value associated with the portable device is transmitted to the portable device via the communicator;

a control of providing the trade object by the minimum trade unit is performed when a response to the request received from the portable device via the communicator indicates that the request is successful; and

a determination on whether or not a next providing to the providing of the trade object by the minimum trade unit relative to the response indicating the success is possible is determined on the basis of a providing status of the trade object,

in which:

when a determination that the next providing is possible is made, a next request of further decreasing the minimum price value from the remaining value associated with the portable device is transmitted to the portable device via the communicator; and

when a determination that the next providing is not ready is made, the trade is ended without a transmission of the next request.

### BRIEF DESCRIPTION OF DRAWINGS

FIG. 1 is an explanatory diagram illustrating an outline of a management device according to an embodiment of the present disclosure;

FIG. 2 is an explanatory diagram illustrating an outline of a trading system including the management device according to an embodiment of the present disclosure;

FIG. 3 is a flowchart illustrating a control flow through a management process executed by the management device according to an embodiment of the present disclosure;

FIG. 4 is a flowchart illustrating a control flow according to an embodiment in which the management device inquires a remaining value beforehand;

FIG. 5 is a flowchart illustrating a control flow through a process executed by the management device when a communication with a portable device is unsuccessful;

FIG. 6 is an explanatory diagram illustrating an external view of a self-service fuel providing machine according to an embodiment of the present disclosure;

FIG. 7A is an explanatory diagram illustrating an appearance with respect to a reader/writer of the self-service fuel providing machine and a holder according to an embodiment of the present disclosure;

FIG. 7B is an explanatory diagram illustrating another appearance with respect to the reader/writer of the self-service fuel providing machine and the holder according to an embodiment of the present disclosure;

FIG. 8 is a display example of a screen for allowing a person subjected to providing to select a payment method;

FIG. 9 is a display example of a screen for allowing the person subjected to the providing to select a trading condition;

FIG. 10 is a display example of a screen for guiding the person subjected to the providing to place a portable device within a communicable range;

FIG. 11 is a display example of a screen for guiding the person subjected to the providing to fit a nozzle in a filler neck, pull a lever, and to start a fuel providing;

FIG. 12 is a display example of a screen for letting the person subjected to the providing to know the providing status of a trade object;

FIG. 13 is a display example of a screen for letting the person subjected to the providing to know a detection of a status in which the next providing of the trade object is not ready;

FIG. 14 is a display example of a screen for letting a person subject to the providing to know the completion of the trade;

FIG. 15 is an explanatory diagram for a level corresponding to a gasoline quantity in a tank;

FIG. 16 is a display example of a screen for letting the person subjected to the providing to know that a communication error with a portable device is occurring;

FIG. 17 is a display example of a screen for letting the person subjected to the providing to know that the providing status error is addressed; and

FIG. 18 is a display example of a screen for letting the person subjected to the providing to know that the remaining value in a portable device is short.

### DESCRIPTION OF EMBODIMENTS

Embodiments of the present disclosure will be explained below. The embodiments are for the explanation purpose only, and are not intended to limit the scope of the present disclosure. Hence, a person skilled in the art could adopt embodiments in which each or all elements in the explanatory embodiments are replaced with equivalents, and such embodiments are also within the scope of the present disclosure.

### First Embodiment

A value in an electronic money system has a worth similar to a cash. The value may be managed by the same currency unit so as to be exchangeable with a cash in a bidirectional or one-way manner, or may adopt a unique unit for the conversion at the time of exchange. In addition, various points given in accordance with the user's action (for example, a purchase of product, a reply to questionnaire, and visiting to a store) are also available as the value.

In this embodiment, an electronic money system called a stored value (stored-value) type is expected. According to the stored-value type system, a value (also referred to as “balance”) that a user can pay as a compensation in a trade is managed in a manner associated with various portable devices, such as a card in which an electronic circuit is built, a mobile phone, and a smart phone.

According to the stored-value type system, the numerical number of the available value is typically stored in the electronic circuit of the portable device. This configuration is equivalent to a condition in which cashes are put in a wallet. In the following explanation, the associated value with the portable device is referred to as a “remaining value (remaining value)” liken to “cashes remaining in a wallet”.

A product or service provider utilizes a reader/writer communicable with the portable device to accept the payment of the compensation from the user. When the user holds the portable device over the reader/writer, a communication between the portable device and the reader/writer is enabled, and when various commands are transmitted from the reader/writer to the portable device, execution results of such commands are also transmitted from the portable device to the reader/writer.

For example, by utilizing an inquiry command, as an execution result, the numerical number of the remaining value presently associated with the portable device is obtainable.

According to a decrease command, the remaining value associated with the portable device is decreased by what corresponds to the specified value in this command. This corresponds to cashes taken out from the wallet. That is, the decrease command is utilized when a compensation is paid in a trade for receiving a provided product or service, that is, at the time of “billing”. In the following explanation, a specified value in the decrease command will be referred to as a compensation value (price value).

An increase command increases the remaining value associated with the portable device by what corresponds to the specified value in this command. This corresponds to cashes put in the wallet. The increase command is utilized when the value equivalent to cashes is charged in the portable device instead of payment by cash to a store staff at a store or the like.

Note that when the portable device has a function of performing a communication via a computer communication network like the Internet, an application activated within the portable device responds to the transmitted command via the computer communication network to obtain, increase or decrease the remaining value associated with the portable device. In this case, the payment of compensation and the charge of the remaining value without the use of reader/writer are enabled.

The increase or decrease of the value in accordance with the decrease command or the increase command means a transfer of the value between a person subjected to the providing and the provider. The provider transmits information on the value transfer to a management server of the electronic money. The management server of the electronic money is operated by the provider of entire electronic money service (operator). When clearance information stored in the management server of the electronic money is tallied, the total quantity of value obtained or lost by the provider within a given time period is obtainable.

When having accomplished the value, the provider is capable of exchanging the value to cashes or the like from the operator, and obtaining cashes in reality. Conversely, when having lost the value, the provider is liable for the payment of cashes or the like for the operator by that value.

According to trades in this embodiment, a trade object is provided with the value of the electronic money being as compensation. In addition, the total provided quantity of trade object provided between the start of a trade and the end thereof is settled upon the end of the trade. Hence, the total provided quantity is not settled until the end of the trade. In this embodiment, a pay-as-you-go billing is expected. Accordingly, the total provided quantity of trade object and the total price value to be paid as the compensation for the total provided quantity are eventually settled upon the completion of the providing of the trade object.

Example such trade objects are products, such as powders (wheat flour, rice brain, powder detergent, and the like), grains (salt, sugar, bead, and the like), liquids (gasoline, mineral spring water, milk, juice, liquor, and the like), gels, and sols which are provided at a constant providing speed from a faucet or a providing port, and which are sold by measure.

In addition, services subjected to time billing in the unit of second or minute (network cafeteria, Internet connection provider, electric-vehicle rental, and the like), and services which perform any processes on a material brought by a person subjected to the providing of the service (copying service utilizing auto sheet feeder, photo printing of all images in USB memory, rice milling of brought rice, and the like) are also services that will be the trade objects.

The management device according to this embodiment controls the payment of compensation in a trade and the providing of the trade object. The payment of compensation is controlled by a communication of the management device with the portable device associated with the remaining value of the electronic money. In addition, the management device controls a providing device and a providing unit that provide a trade object itself, but the providing device and unit may be independent apparatuses from the management device, respectively, or may be an integrated device as a whole.

A target providing quantity and an upper limit providing quantity may be set for the providing device, and the like. The providing devices, and the like, keep providing the trade object until the provided quantity of the trade object from the start of trade reaches the target providing quantity unless an event that should end the providing (for example, fuel providing nozzle is detached from vehicle, and returned to self-service fuel providing machine, ADF becomes empty and copying of all documents has been completed, and forcible termination instruction is given through user instruction) occurs. In addition, the providing device, and the like, always complete the providing when the provided quantity of the trade object reaches the upper limit providing quantity.

The management device in this embodiment may be configured by special-purpose electronic circuits, or may be accomplished by a computer that executes programs. In addition, as an intermediate configuration between a computer and a special-purpose electronic circuit, technologies like Field Programmable Gate Array (FPGA) which compile a program in the design scripts for an electronic circuit, and which dynamically configure the electronic circuit on the basis of the design script may be applied to accomplish the management device in this embodiment.

In the following paragraphs, first, an explanation will be given of a general configuration of the management device that manages trades utilizing the value of the electronic money, but in order to facilitate understanding, applied case examples to a self-service fuel providing machine and a copying service utilizing the ADF will be explained as necessary. In addition, details of the applied case examples to the self-service fuel providing machine and the copying service utilizing the ADF will be explained at the last.

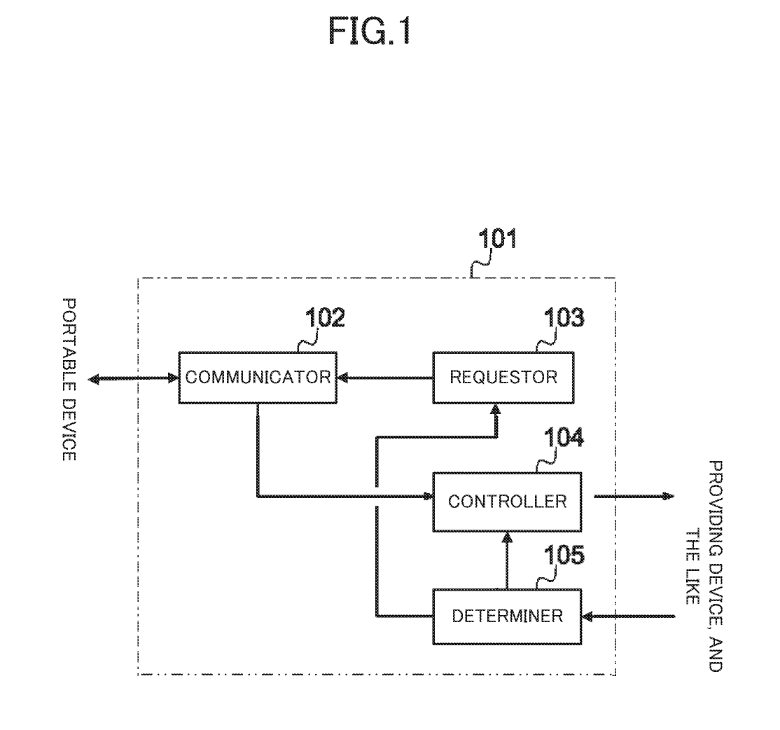

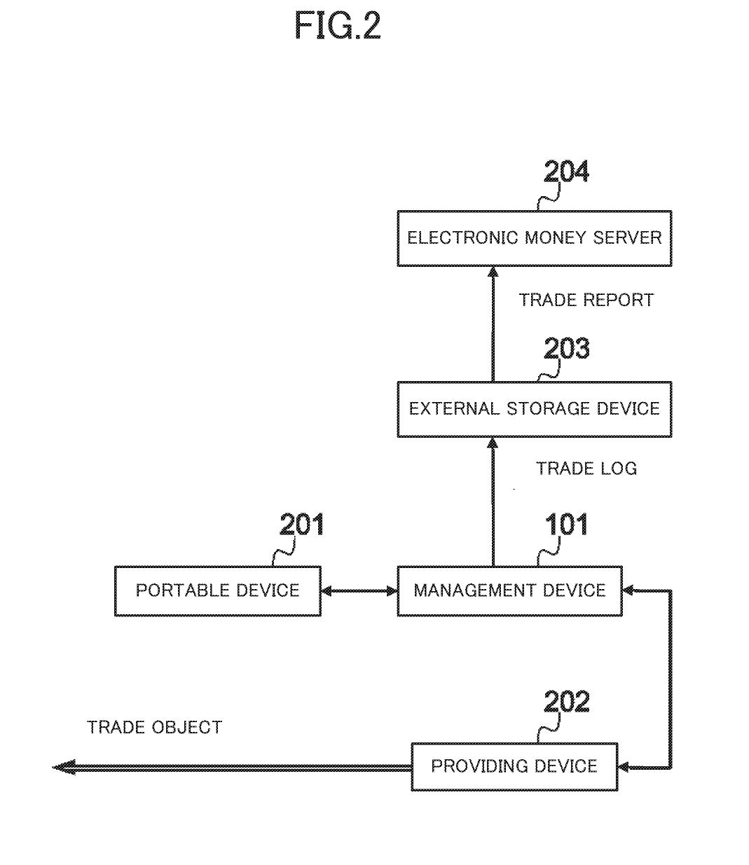

FIG. 1 is an explanatory diagram illustrating an outline of the management device according to this embodiment of the present disclosure. FIG. 2 is an explanatory diagram illustrating an outline of a trading system including the management device according to this embodiment of the present disclosure. The following explanation will be given with reference to those figures.

A management device 101 in this embodiment includes a communicator 102, a requestor 103, a controller 104, and a determiner 105.

In this case, the communicator 102 communicates with a portable device 201 located within a communicable range. For example, the communicator 102 may be accomplished by a reader/writer for electronic money. In this case, when the portable device 201 is held over the reader/writer for electronic money, the portable device 201 enters the communicable range with the communicator 102. In this embodiment, a short-range wireless communication (Near Field Communication: NFC) is applied for the communication between the communicator 102 and the portable device 201. Note that the infrared ray communication or the Bluetooth (Bluetooth (registered trademark)) may be applied for the communication between the communicator 102 and the portable device 201.

Conversely, the requestor 103 transmits, to the portable device 201 via the communicator 102, a request of decreasing the minimum price value from the remaining value associated with the portable device 201. In this embodiment, this request is accomplished by the decrease command.

In addition, the minimum price value is defined by either the provider of a trade object or the person subjected to the providing or the agreement therebetween, and is entered to or set for the management device 101. In this case, the provider of the trade object sets the minimum providing unit of the trade object in view of the real nature of trades, and the like, and sets the compensation corresponding to the minimum unit as the minimum price value.

Note that the electronic money is capable of simplifying and facilitating the payment of a small amount of money, and the minimum price value that is the minimum currency unit (1 YEN in Japan, 1 cent in America, 1 centime in EU, 1 cent in Hong Kong, and the like) is applicable. In addition, when various points are adopted as the electronic money, the minimum unit of such a point system may be adopted. Still further, the multiple number of the minimum currency unit or the minimum unit of the point, such as 3 YEN, 5 cents, 10 centimes, 25 points, may be adopted as the minimum price value.

Note that when the minimum price value is too small, the clearance information exchange between the provider and the electronic money system operator may become a huge quantity. Conversely, when the minimum price value is too large, the providing unit of the trade object becomes large, and thus an event in which the providing of the trade object should be discontinued during such a providing by what corresponds to such a unit is likely to occur. Hence, in view of the real nature of trades, and the like, the minimum price value should be set.

When a response to the request is received from the portable device 201 via the communicator 102, and the response indicates that the request has been successful, the controller 104 performs a control so as to provide the trade object by the minimum trade unit which is provided with the minimum price value being as the compensation, that is, the trade object by the minimum providing quantity.

The minimum price value and the minimum providing quantity are in a relationship in which when the one is defined, the other is automatically defined, and in general, defined in view of the hardware limit value like the accuracy of the flow meter of the fuel providing machine applied for the fuel providing. When, for example, the trade object is gasoline that has a price of 160 YEN per a liter (1000 milliliter), and when the measurement accuracy of the flow meter is 0.01 mL, the minimum providing quantity is set to 6.25 mL, and the minimum price value is set to 1 YEN. When the measurement accuracy of the flow meter is 0.1 mL, the minimum providing quantity is set to 12.5 mL, and the minimum price value is set to 2 YEN. When the measurement accuracy of the flow meter is 0.1 L, the minimum providing quantity is set to 0.1 L, and the minimum price value is set to 16 YEN.

Note that when the broken number is acceptable for the minimum price value, the minimum providing quantity may be set to 0.1 mL or 0.01 mL, and when the broken number is not acceptable, the minimum providing quantity should be adjusted in such a way that the minimum price value becomes an integer. Alternatively, the minimum providing quantity may be a quantity that can be set as needed by the provider in view of the real nature of trades, and the like instead of the consideration on the hardware limit value like the precision of the flow meter of the fuel providing machine for fuel providing.

At the start of the trade, the target providing quantity is zero. When the received response indicates the success, this means that the remaining value associated with the portable device 201 is decreased by the minimum price value. That is, since the compensation for the providing is paid by what corresponds to the minimum price value, the target providing quantity increases by what corresponds to the minimum providing quantity equivalent to the minimum price value. As explained above, according to this embodiment, a control of the providing of the trade object by the minimum providing quantity increases the target providing quantity at the providing device 202 by the minimum providing quantity.

Note that the management device 101 transmits the various commands to the portable device 201, and the execution result of the command specified in the received response is stored in, as a trade log, an external storage device 203 from the reader/writer that is the communicator 102 of the management device 101. In addition, a trade report that collects up those trade logs is transmitted to a management server 204 of the electronic money at a constant cycle, for example, once per a day. The management server 204 of the electronic device defines the amount of money that should be exchanged with the provider of the trade object that handles the electronic money on the basis of the trade report, and the account for such an amount of money is adjusted at a constant cycle, for example, once per a month.

The determiner 105 determines whether or not the next providing to the providing by the minimum providing quantity corresponding to the response indicating the success is possible on the basis of the providing status of the trade object. When a determination that the next providing is possible is made, the requester 103 transmits, to the portable device 201 via the communicator 102, a next request of further subtracting the minimum price value from the remaining value associated with the portable device 201. When the decrease of the next minimum price value in the portable device 201 is successful by this transmission, a control of the next providing by the minimum providing quantity is performed, and thus the target providing quantity further increases.

Conversely, when a determination that the next providing is not ready is made, the requestor 103 does not make the next request, and the controller 104 ends the trade. That is, unless an event that interrupts the providing occurs after the determination, the trade object is being provided up to the target providing quantity, and the trade ends. When no interruption event occurs, the trade will end upon the completion of the providing by the minimum providing quantity corresponding to the response that indicates the success.

The determination on whether or not the next providing is possible may have various conditions set in accordance with the trade object to be provided as explained below.

That is, when this embodiment is applied to a self-service fuel providing machine, a determination that the next providing is possible is made unless an automatic stop on the basis of the detection of the gasoline quantity exceeding a certain level occurs up to the present determination, and a determination that the next providing is not ready is made when the automatic stop has occurred. Note that the automatic stop may be too sensitive depending on the shape of a tank and that of a nozzle. Hence, the determination on whether or not the next providing is possible may be made on the basis of the number of occurred automatic stops until the present determination since the last determination.

Note that when the threshold for the gasoline quantity at which an excess beyond the certain level is detected in relation to the automatic stop is set as a gasoline quantity (level X) at which the gasoline will leak from the tank when provided more than this gasoline quantity, a hazardous possibility that the gasoline leakage occurs may become quite high. Hence, according to this embodiment, the gasoline quantity that causes the automatic stop is set to be a level Z that is smaller than the level X by a certain margin quantity. Even if the gasoline is further provided after the gasoline quantity has reached the level Z, the gasoline leakage does not occur up to the margin quantity.

As for the fuel providing beyond the level Z, when a handle is squeezed gently to obtain a quite small flow rate, the risk of fuel leakage from the tank may be minimized, and by setting the appropriate margin level, the fuel providing is enabled up to the marginal quantity corresponding to the billed amount of money. However, the person subjected to the providing may discard the remaining quantity exceeding the level Z.

When this embodiment is applied to a self-service fuel providing machine as explained above, and when the automatic stop is detected (by predetermined times), no further billing is made, but the gasoline can be provided up to the target providing quantity that is presently set.

In addition, in the case of a copying service utilizing the ADF, a determination on whether or not the next providing is possible is made on the basis of whether or not the document is left in the ADF.

In this embodiment, during the trade between the start of the trade and the end thereof, the portable device 201 is being held within the communicable range of the communicator 105. In addition, the billing is made minimum price value by minimum price value, producing no changes. Hence, according to this embodiment, a failure of receiving the value corresponding to changes does not occur.

In addition, according to this embodiment, prior to the start of the providing by the minimum providing quantity, the decrease of the minimum price value that is the compensation for such a providing of the trade object is repeated to enable the sequential providing by the minimum providing quantity, and to reduce the total providing time necessary for the providing by the total providing quantity without an interruption of the providing of the trade object.

In order to enable the sequential providing of the trade object and to suppress the excessive billing (decrease of minimum price value in portable device), the determination on whether or not the next providing is possible may be made after the start of the providing of the trade object by the minimum providing quantity corresponding to the response that indicates the success, and prior to the completion of the providing, and the next request may be transmitted prior to the completion of the providing of the trade object by the minimum providing quantity corresponding to the response that indicates the success.

That is, as the present providing status, the already provided quantity of the trade object that has been provided up to the present time after the start of the trade is utilized, and when the already provided quantity is equal to or greater than “a value that is the target providing quantity from which the minimum providing quantity is subtracted”, and less than the “target providing quantity”, the determination and the next request are made. More simply, at a time point at which the already provided quantity just reaches “the value that is the target providing quantity from which the minimum providing quantity is subtracted”, the determination is instantaneously made.

For example, in the case of the self-service fuel providing machine, the gasoline corresponding to a price value V per a request is to be provided by G mL. In this case, when the requests from the first time to the n-th time are successful, the decreased total value by the billing is n×V, and the target providing quantity becomes n×G mL.

Next, the determination on the (n+1)-th compensation, the transmission of the request, the reception of the response, and the update of the target providing quantity are made with a time period:

1. after the providing of the trade object by the (n−1)-th time completes and the providing by the n-th time sequentially starts; and

2. until the providing by the n-th time completes, that is, when the already provided total quantity is (n−1)×G milliliter and n×G milliliter,

In the case of a copying service that utilizes the ADF, the determination is made immediately after one document is loaded from the ADF, and in parallel with the copying work of the loaded document, whether or not the document is left in the ADF is detected to make the determination. When the document is left, the determination that the next providing is possible is made, the request is transmitted and the remaining value is decreased. That is, in parallel with the copying work of the loaded document, the billing for the copying work of the next document is made.

When a determination is instantaneously made at a time point at which the already provided quantity reaches “the value that is the target providing quantity from which the minimum providing quantity is subtracted”, and the determination that the next providing is possible is made, the target providing quantity is further increased by the minimum providing quantity. Hence, with reference to the time point at which the determination that the next providing is possible is instantaneously made, subsequently, the trade object by the quantity twice as much as the minimum providing quantity is to be provided.

In the case of a copying service that utilizes the ADF, for example, after the determination, a service for at least the documents that are the document being copied in parallel with the determination and the document left in the ADF is provided.

The communicator 102 of the management device 101 according to this embodiment is accomplished by the reader/writer in the stored-value type system, and the requestor 103, the controller 104, and the determiner 105 are accomplished by the Central Processing Unit (CPU) of the computer that runs programs or by the activated electronic circuit for the control.

The example control by the management device 101 will be explained below in more detail. In the following explanation, the determination timing is set in accordance with the above example.

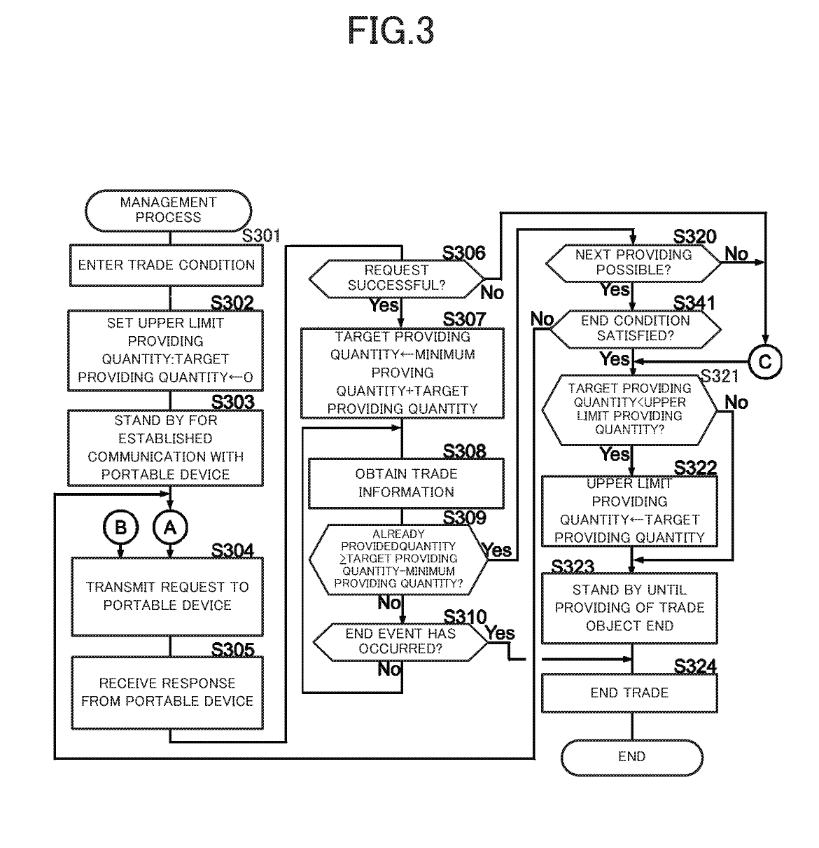

FIG. 3 is a flowchart illustrating the control flow through the management process executed by the management device according to this embodiment of the present disclosure. The explanation will be given below with reference to this figure.

First, the management device 101 accepts (step S301) the trade condition that is entered by the person subjected to the providing. This step is equivalent to the start of the trade.

Next, the management device 101 sets the upper limit providing quantity on the basis of the entered trade condition, and resets the target providing quantity to zero (step S302).

Subsequently, the management device 101 stands by (S303) until the communicator 105 establishes a communication with the portable device 201.

After the communication is established, the requestor 103 transmits (step S304) the request of specifying the decrease command of the minimum price value to the portable device 201 via the communicator 105.

Next, the management device 101 receives (step S305) the response from the portable device 201 via the communicator 105.

Subsequently, the controller 104 checks (step S306) whether the received response indicates that the request is successful or that the request is unsuccessful.

When the request is successful (step S306: YES), the controller 104 increases (step S307), by the minimum providing quantity, the target providing quantity by the providing device 202.

Next, the management device 101 obtains (step S308), in addition to the already provided quantity of the trade object provided from the start of the trade and up to the present time, the providing status of the trade object from the providing device 202.

Subsequently, the management device 101 checks (step S309) whether or not the already provided quantity has reached the present “value (equal or above) that is the target providing quantity from which the minimum providing quantity is subtracted”.

When not reached (step S309: NO), whether or not an event that should end the providing is occurring (step S310). When no event that should end the providing is occurring (step S310: NO), the management device 101 returns the process to the step S308. By repeating the processes in the steps S308-310, while the providing by the n-th billing is being carried out, the (n+1)-th request is made, but the (n+2)-th request is not made yet, and the management device stands by as for such a request. Conversely, when the event that should end the providing is occurring (step 310: YES), the management device 101 progresses the process to step S324 in order to end the trade.

In the case of the self-service fuel providing machine, the event which should end the trade and in which “the nozzle is detached from the vehicle and is returned to the stand” is applicable. According to this example, the person subjected to the providing is capable of ending the trade by simply “removing the nozzle from the vehicle and returning the nozzle to the stand”.

When the already provided quantity has reached the “quantity that is the target providing quantity from which the minimum providing quantity is reduced” (step S309: YES), the determiner 105 determines (step S320) whether or not the next providing is possible on the basis of the obtained providing status.

When the determination that the next providing is possible is made (step S320: YES), the management device 101 returns the process to the step S304 through the process to be explained later, and repeats the processes of decreasing the minimum price value and of increasing the target providing quantity, and thus the trade object is provided in sequence.

When the determination that the next providing is not ready is made (step S320: NO), the management device 101 compares (step S321) the target providing quantity set for the providing device 202 with the upper limit providing quantity. When the target providing quantity is smaller than the upper limit providing quantity (step S321: YES), the management device 101 sets (step S322) the target providing quantity that is the upper limit providing quantity, and progresses the process to step S323. When not so (step S321: NO), the management device 101 directly progresses the process to step S323.

Next, the management device 101 stands by (step S323) until the providing device 202 completes the providing of the trade object. In addition to the event in which the already provided quantity has reached the upper limit providing quantity during the stand-by, when the event that should end the trade occurs, the providing device 202 ends the providing of the trade object.

When the providing device 202 completes the providing of the trade object, the trade is ended (step S324), and this process is finished. When the trade ends, a value obtained by multiplying the number of successful requests between the start of the trade and the end thereof by the minimum price value is taken as the total compensation, and a receipt or a voucher that shows the total provided quantity which is the target providing quantity or the present already provided quantity is issued, and this receipt or the like is preferably given to the person subjected to the providing.

When the request is unsuccessful (step S306: NO), the process also progresses to the step S321. The trade is ended through the subsequent process.

When the event that should end the trade has occurred (step S310: YES), the management device 101 progresses the process to the step S324, and ends the trade.

According to this process, since no change value is produced, an occurrence of the occasion in which the person subjected to the providing fails to get the change value is avoidable.

In addition, when a given decrease command for the minimum price value is successful and the compensation is paid, and while the providing of the trade object by the minimum providing quantity relative to this compensation is performed, the determination on whether or not the next minimum providing quantity is possible is made. This enables the sequential providing of the trade object by each minimum providing quantity without any interruption, thereby reducing a total providing time.

When the determination that the next providing is possible is made (step S320: YES), the process may be immediately returned to the step S304, but a determination on whether or not the end condition that should end the trade is satisfied may be made (step S341), and the process may be returned to the step S304 when the end condition is unsatisfied (step S341: NO), or the process may be progressed to the step S322 when the end condition is satisfied (step S341: YES).

The person subjected to the providing is allowed to set and enter the end condition prior to the start of the trade and at the time of the start thereof. For example, in the case of the self-service fuel providing machine, conditions such that “gasoline can be provided up to XXX YEN at maximum”, “gasoline can be provided up to YYY L at maximum” may be set.

In addition, after the start of the trade, and while the trade object is being provided, the person subjected to the providing is allowed to enter a predetermined instruction to the management device 101 so as to satisfy the end condition. This corresponds to, for example, when the operation “to stop the providing of gasoline” is given in the case of the self-service fuel providing machine.

When such end condition is satisfied, the trade is ended after the trade object is provided up to the target providing quantity unless the event that should end the providing (for example, “the nozzle is detached from the vehicle and returned to the stand”) occurs.

As explained above, according to this embodiment, after the payment of the value by electronic money is made, the providing of the trade object relative to this value starts. This prevents the person subjected to providing from taking the trade object without a payment, enabling a safe trade when, in particular, the providing of service is operated in a substantially unattended manner like an automatic vending machine or a self-service-style providing device.

In addition, in the case of a configuration in which the deposited value (deposit value) is settled up prior to the start of the providing of the trade object, and the value equivalent to changes (change value) is returned at a certain time point after the end of the providing, when the person subjected to the providing forgets receiving the change value and leaves the store or the like, a clearance process may be necessary later. According to this embodiment, however, the return process of any change value is inherently unnecessary. Hence, a construction of the mechanism of returning the change value is unnecessary, and thus the operation of the electronic money system can be carried out easily and inexpensively.

According to this embodiment, repeated actions, such as to provide a little quantity of gasoline, to stop the providing of gasoline, to bill by the provided quantity of gasoline, and to provide again a little quantity of gasoline, are unnecessary. That is, according to the scheme of this embodiment, a product or a service can be sequentially provided, and thus the total time necessary for the providing can be reduced, and an error in the total provided quantity relative to the paid compensation can be reduced.

In addition, according to this embodiment, the person subjected to the providing is capable of getting the providing of the trade object by the total provided quantity corresponding to the total price value paid by such a person without an insufficiency unless indicating the willing of discard.

Note that the control flow according to this embodiment can be change as appropriate. For example, the sequences of the steps S301-S303 may be interchanged, and the trade condition may be entered after a communication with the portable device is established.

### Second Embodiment

In the above embodiment, by utilizing the decrease command in the stored-value scheme, the requestor 103 transmits (step S304) the request to the portable device 201 via the communicator 102, and a determination on whether or not the request has been succeeded is made on the basis of the returned response.

In this embodiment, prior to the transmission of the request (step S304), the amount of the remaining value associated with the portable device 201 is obtained.

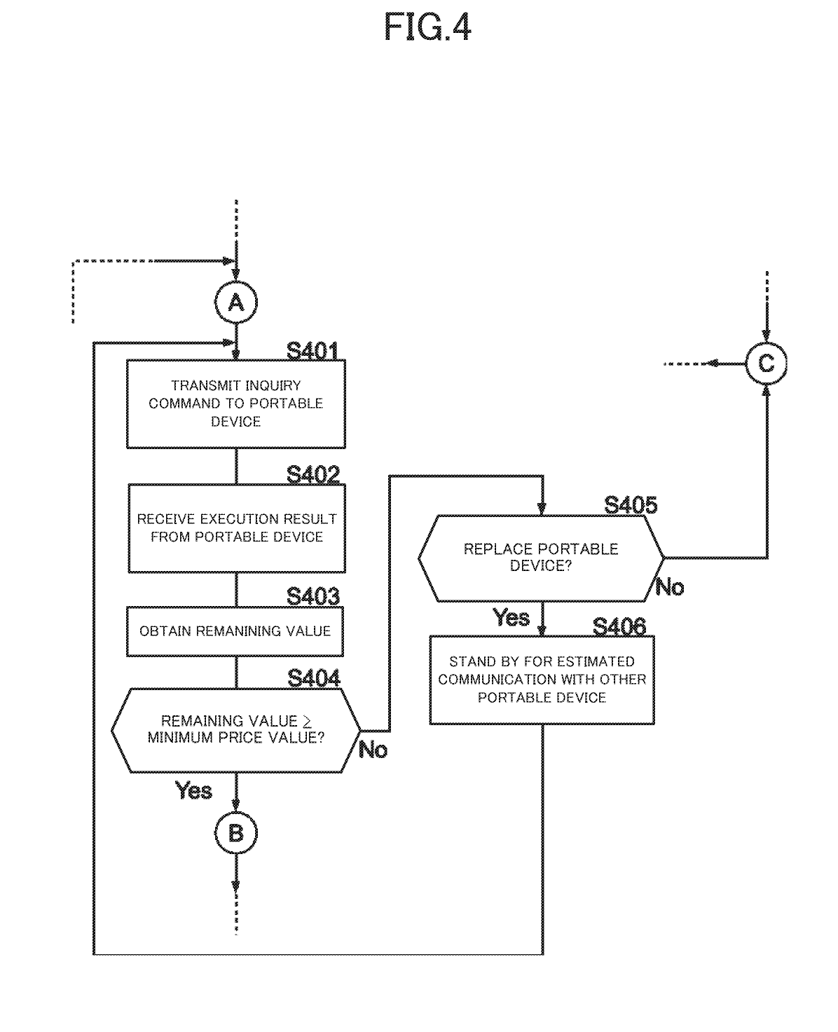

FIG. 4 is a flowchart illustrating a control flow in an embodiment in which the management device inquires the remaining value beforehand. An explanation will be given below with reference to this figure.

According to this embodiment, in the flowchart that is FIG. 3, after the communication between the communicator 102 and the portable device 201 is established (step S303), the management device 101 transmits (step S401) an inquiry command to the portable device 201 via the communicator 102.

Next, the management device 101 receives (step S402) the execution result of the inquiry command transmitted from the portable device 201 via the communicator 102. Subsequently, the management device obtains (step S403) the remaining value associated with the portable device 201 from the received execution result.

Next, the management device 101 compares the obtained remaining value with the minimum price value, and when the remaining value is equal to or larger than the minimum price value (step S404: YES), the request will be successful, and thus the process progresses to the step S304.

Conversely, when the remaining value is less than the minimum price value (step S404: NO), the request will be unsuccessful, and thus the process may progress to the step S321 to end the trade without a request being transmitted. In this embodiment, however, the person subjected to the providing is notified of the shortage of the remaining value, and a reply for whether or not to replace the portable device 201 is requested (step S405).

When the person subjected to the providing gives a reply to replace the portable device 201 (step S405: YES), the management device stands by until a communication with the other portable device 201 is established (step S406), and the process returns to the step S401.

Conversely, when a reply not to replace the portable device 201 is given (step S405: NO), the process progresses to the step S321 to end the trade. Note that when the process is left for a certain time period without any reply, the process typically progresses to the step S321 to end the trade (illustration is omitted).

Note that while those processes are being executed, the providing device 202 keeps providing the trade object up to the target providing quantity in parallel with those processes.

When the determination that the next providing is possible is made (step S320: YES), the management device 101 returns the process to the step S401 instead of returning to the step S304.

In the above control flow, the inquiry command is transmitted every time right before the decrease command is transmitted, but the numerical number of the remaining value obtained by the initial inquiry may be stored in the memory of the management device 201 so as to reduce the transmission number of inquiry commands.

That is, every time the request is successful and the target providing quantity increases (step S307), the numerical number stored in the memory is decreased, and instead of the comparison (step S404) between the remaining value and the minimum price value, a comparison between the stored numerical number in the memory and the minimum price value is executed.

According to this embodiment, by inquiring the amount of the remaining value beforehand, the person subjected to the providing is allowed to smoothly replace the portable device 201 when the presently utilizing portable device 201 has the insufficient remaining value.

### Third Embodiment

In the above embodiments, once the communication between the portable device 201 and the communicator 102 is established, a case in which this communication is kept between both the portable device and the communicator until the completion of the providing of the trade object is expected.

When, however, the management device 101 transmits the decrease command or the inquiry command via the communicator 102, a communication with the portable device 201 may become unsuccessful, and the execution result of the command may be unobtainable in some cases.

In this embodiment, a time out is set for the communication between the communicator 102 of the management device 101 and the portable device 201.

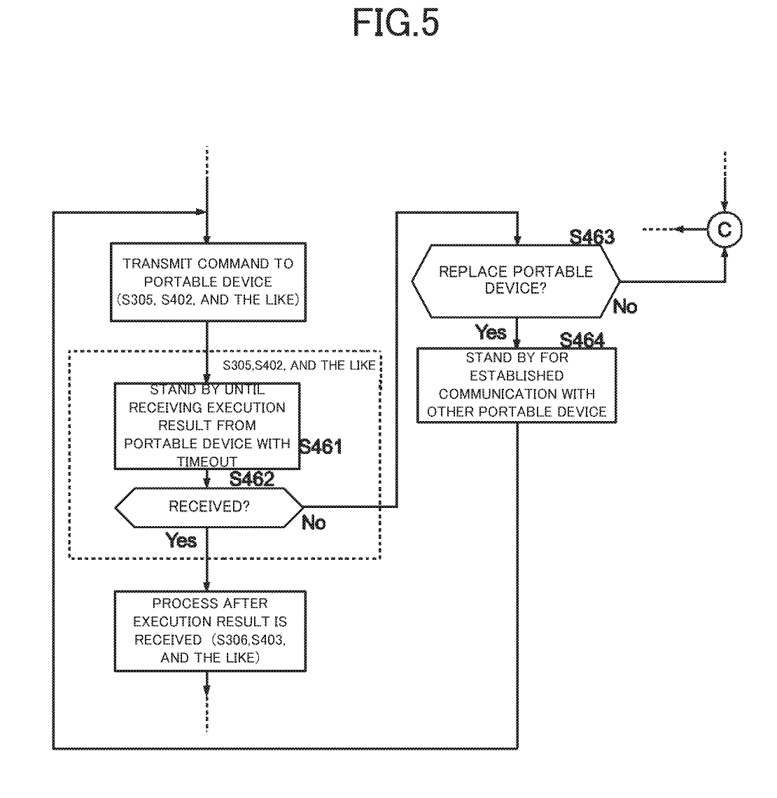

FIG. 5 is a flowchart illustrating a control flow of the process executed by the management device when a communication with the portable device is unsuccessful. An explanation will be given below with reference to this figure.

That is, when the request (decrease command) or the inquiry command is transmitted (steps S304, S401, and the like) to the portable device 201, the management device stands by (step S461) until receiving (steps S305, S402, and the like) a response (execution result of decrease command) and the execution result of the inquiry command for a predetermined threshold time that is the set time-out period.

After the stand by, the management device determines (step S462) whether or not the execution result is received. When received (step S462: YES), the process progresses to steps (steps S306, S403) subsequent to the reception of the execution result (steps S305, S402, and the like).

When the execution result of the command is not received within the predetermined threshold time (step S462: NO), a notification that the communication with the portable device 201 is unsuccessful is given to the person subjected to the providing, and a reply for whether or not to adjust the position of the portable device 201 relative to the communicator 102 or to replace the portable device 201 is requested (step S463).

When the person subjected to the providing gives a reply (step S463: YES) to adjust the position of the portable device 201 or to replace, the management device stands by (step S464) until a communication with the other portable device 201 is established, and the process returns to the step of transmitting the command (steps S304, S401, and the like). Hence, the requestor 103 of the management device 101 transmits again the request to the portable device 201 via the communicator 102.

Conversely, when a reply not to adjust the position of the portable device 201 or not to replace is given (step S463: NO), the process progresses the step S321 to end the trade. Note that when the process is left for a certain time period without any reply, the process typically progresses to the step S321 to end the trade (illustration is omitted).

According to this embodiment, when the communication between the portable device 201 and the communicator 102 is unsuccessful, the person subjected to the providing is facilitated to adjust the position of the portable device 201 or to replace the portable device.

In addition, according to this embodiment, the person subjected to the providing is capable of easily ending the trade by simply moving the portable device 201 apart from the communicator 102 so as to discontinue the communication.

### Fourth Embodiment

This embodiment is a suitable form of the above embodiments, and the present disclosure is applied to a self-service fuel providing machine at a gas station. In order to facilitate understanding, the explanation for the common feature and the already explained feature will be omitted below as appropriate.

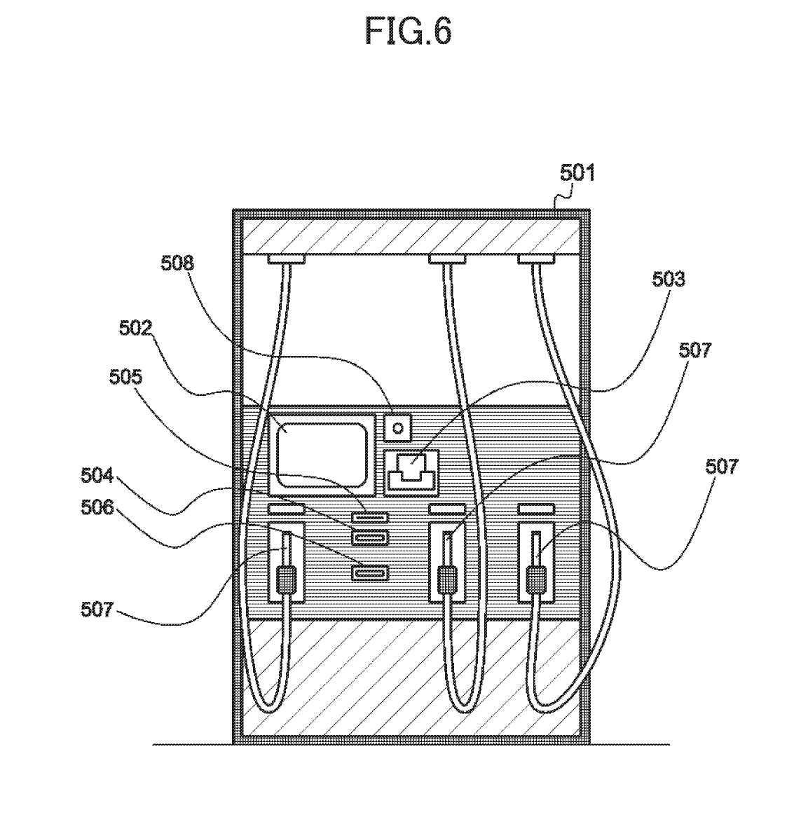

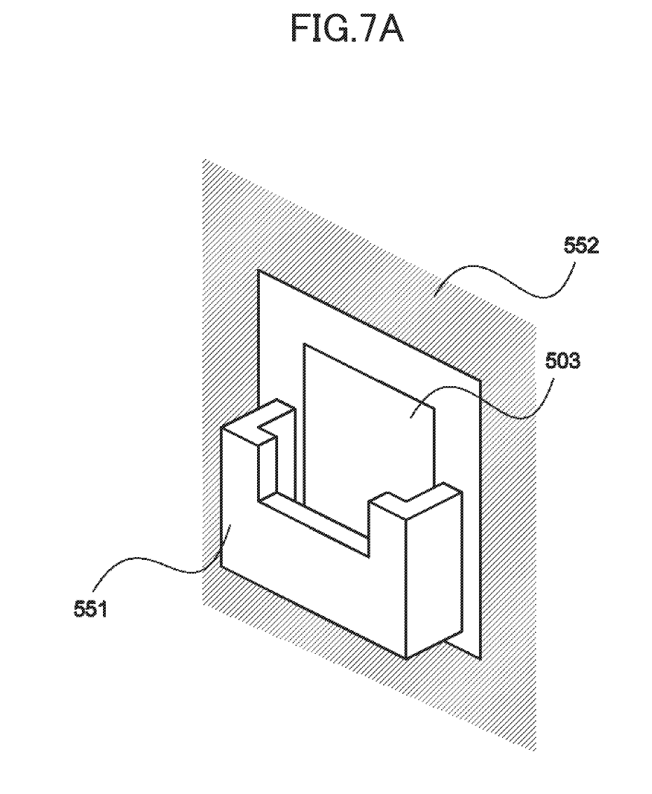

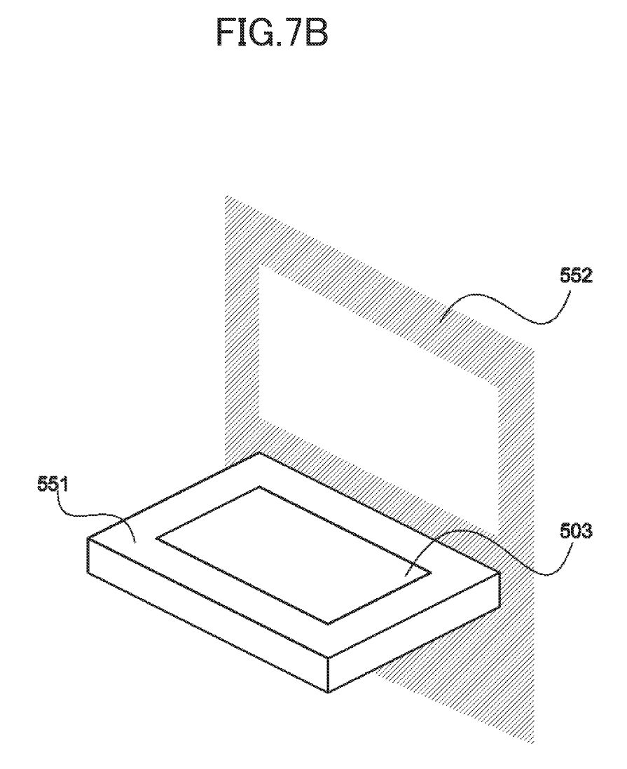

FIG. 6 is an explanatory diagram illustrating an external appearance of a self-service fuel providing machine according to this embodiment. FIG. 7A is an explanatory diagram illustrating an appearance with respect to the reader/writer of the self-service fuel providing machine and a holder according to this embodiment. An explanation will be given below with reference to those figures.

A self-service fuel providing machine 501 includes an operation panel 502 to exchange various information with the person subjected to the providing, a reader/writer 503 over which the person subjected to the providing holds the portable device 201 that is to be utilized for the payment of the compensation, a cash loading slot 504, a card loading slot 505, a printer 506, a nozzle 507 for providing gasoline or the like, and a camera 508.

The person subjected to the providing views various messages displayed on the touch screen, the display, various lamps, or the like, of the operation panel 502 to obtain information, and gives various instruction operations by touching the surface of the touch screen, buttons, and various keys. In addition, information may be exchanged by voice and sound through prepared speakers and microphone.

The cash loading slot 504 is to load a paper money as prepayment when cashes are utilized for the payment of compensation, and the card loading slot 505 is to load a card when a credit card, a debit card, or a prepaid card is utilized for the payment of compensation.

The reader/writer 503 allows the person subjected to the providing to hold the portable device 201 over such a reader/writer for a communication when electronic money is utilized for the payment of compensation.

As illustrated in this figure, when the surface of the reader/writer 503 is substantially vertical along a front surface 552 of the self-service fuel providing machine 501, or when the surface of the reader/writer 503 is oblique along the recess provided in the self-service fuel providing machine 501, and the like, a holder 551 illustrated in the figure is utilized which restricts the movement of the portable device 201 or supports the portable device 201 so as to suppress a falling of the portable device 201 and a withdrawal from the reader/writer 503 and from the communicable range.

In addition, due to the dimensional increase of smartphones and the like, the holder 551 illustrated in FIG. 7A may sometimes be unable to support the portable device 201. FIG. 7B illustrates another appearance with respect to the reader/writer of the self-service fuel providing machine and a holder according to this embodiment of the present disclosure. The holder 551 in this figure is formed in a shape like a tray disposed substantially horizontally, and the reader/writer 503 is disposed on the surface thereof. When the tray-like holder 551 is applied or when the surface of the reader/writer 503 is substantially horizontal and has a sufficiently wide area to place thereon the portable device 201, the person subjected to the providing can simply place the portable device 201 on that surface between the start of a trade and the end thereof. In view of the prevention of the falling of the portable device 201, the tray-like holder 511 and the relatively large surface of the reader/writer 502 having the substantially horizontal surface should be desirably a descending slope slightly toward the front surface 552 of the self-service fuel providing machine 501.

When a credit card or the like is utilized, the card is loaded in the card loading slot 505 at the start of the trade, and this card is ejected from the card loading slot 505 at the end of the trade. Hence, a mechanism for putting a card in and out is necessary for the card loading slot 505.

Conversely, when the electronic money is utilized, a payment is enabled as long as the portable device 201 is held over the surface of the reader/writer 503 and is located within the communicable range. Hence, the portable device 201 may be simply supported by a simple and inexpensive structure like the holder 551.

The printer 506 prints out a receipt or a voucher after the completion of the trade.

The camera 508 detects the person subjected to the providing who is visiting the store. This enables the self-service fuel providing machine 501 to transition the operation mode from the energy saving mode to the normal mode. In addition, for the purpose of security, images of the external appearance of the person subjected to the providing and those of a vehicle to which gasoline is provided may be picked up.

The self-service fuel providing machine 501 illustrated in this figure is provided with three nozzles 507 in accordance with the kinds of fuel, and the number of nozzles may be changed as appropriate in accordance with the kinds of fuel or the like for sale. Gasoline or the like flows out at the maximum flow rate while the lever of the nozzle 507 is fully pulled until the fill-up condition is satisfied. Note that in the self-service fuel providing machine 501, a locking mechanism may be applied with the lever of the nozzle 507 being fully pulled, thereby enabling a hands-free fuel providing.

When the quantity of gasoline in the tank reaches the level Z, and the automatic stop condition being satisfied is detected, the lever fully pulled is forcibly returned, and the locking mechanism for the hands-free fuel providing is canceled. In addition, while the automatic stop condition is satisfied, the lever cannot be fully pulled or no gasoline is provided even if the lever is fully pulled. In this case, when the lever is pulled gently, gasoline is provided at a quite little flow rate. As explained above, even while the automatic stop condition is satisfied, a little quantity of gasoline can be provided up to the margin quantity.

The self-service fuel providing machine 501 is connected to, via a Local Area Network (LAN) in the sales store, a change returning machine (unillustrated) by cash, a register (unillustrated) in the store where a store staff is present, the external storage device 203 for recording the sales log for the trade via the self-service fuel providing machine 501, and the like.

Each component of such self-service fuel providing machine 501 is controlled by an unillustrated CPU that executes predetermined programs or a special-purpose electronic circuit.

When the person subjected to the providing gets the fuel providing or the like via the self-service fuel providing machine 501 using electronic money, the similar controls to those of the above embodiments are executed.

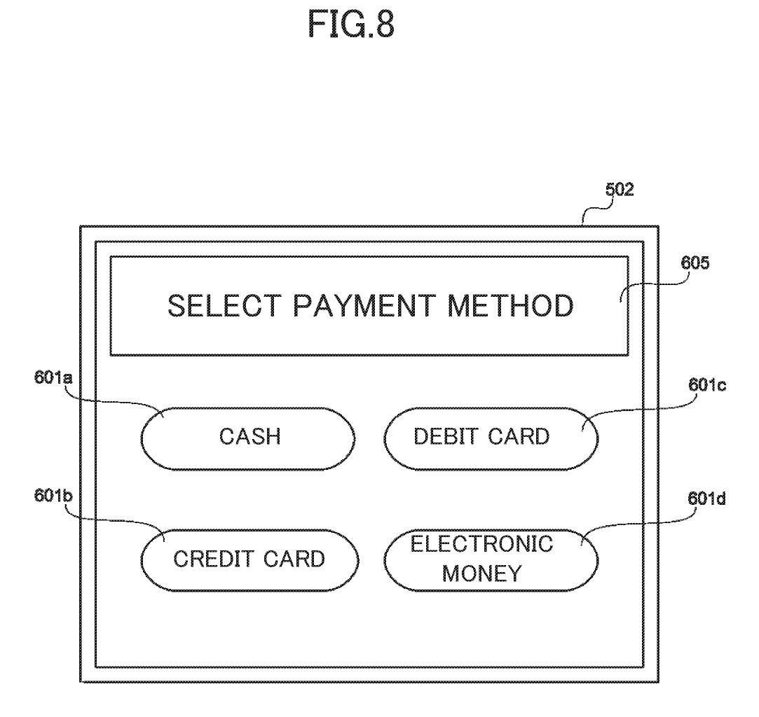

First, the self-service fuel providing machine 501 causes the person subjected to the providing to select the payment method at the start of the trade. FIG. 8 is a display example of a screen for allowing the person subjected to the providing to select the payment method. According to the example illustrated in this figure, payment method buttons 601a-601d for the payment by cash, credit card, debit card, and electronic money, respectively, are displayed on the touch screen of the operation panel 502, and a message that prompts the person subjected to the payment to select any payment method is displayed on a message display field 605.

When the person subjected to the payment touches any of the payment method buttons 601a-601c, conventional trade procedures are executed. When the payment method button 601d is touched, the trade procedures according to this embodiment start.

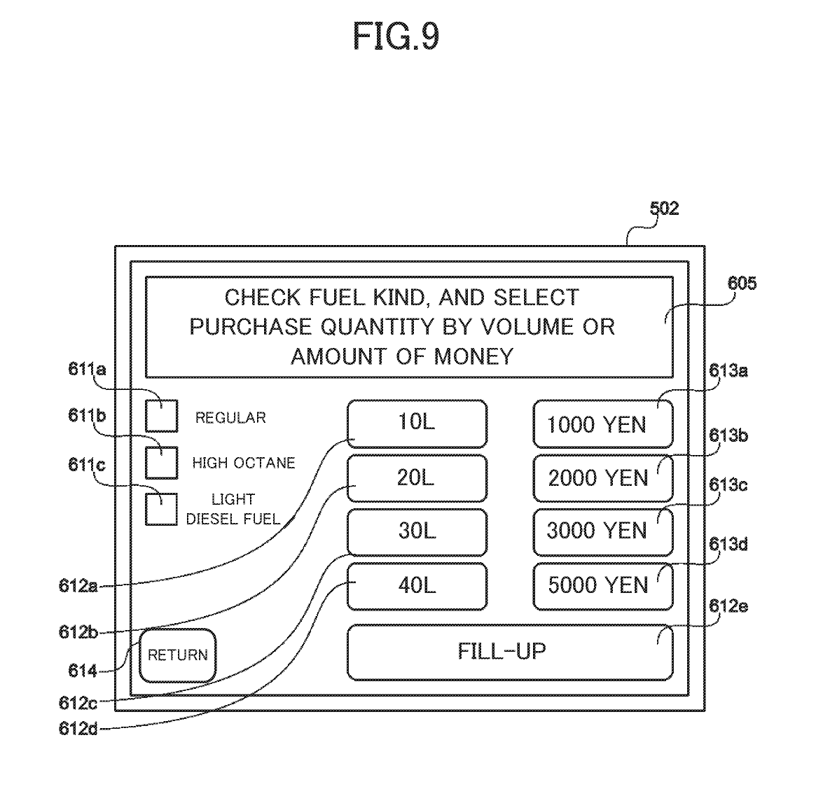

When the payment by electronic money is selected, the self-service fuel providing machine 501 prompts the person subjected to the providing to enter the trade condition. FIG. 9 is a display example of a screen for allowing the person subjected to the providing to select the trade condition. According to the example illustrated in this figure, fuel kind check boxes 611a-611c for selecting the kind of fuel that is regular, high octane, or light diesel oil are displayed on the touch screen of the operation panel 502.

In addition, upper limit quantity buttons 612a-612e for selecting the providing quantity of gasoline that is 10 L, 20 L, 30 L, 40 L or full are also displayed on the touch screen of the operation panel 502.

Still further, upper limit amount buttons 613a-613d for selecting the payment amount that is 1000 YEN, 2000 YEN, 3000 YEN, or 5000 YEN to set the providing quantity of gasoline are displayed on the touch screen of the operation panel 502.

Yet still further, a message of prompting the person subjected to the providing to select any is displayed on the message display field 605.

In addition, when operating a return button 614, the person subjected to the providing is capable of starting over the entering operation from the beginning.

When the person subjected to the providing has selected any of the fuel kind check box 611a-611c and touches any of the upper limit quantity buttons 612a-612e or any of the upper limit amount buttons 613a-613d, the trade condition is entered (step S301) through those selections.

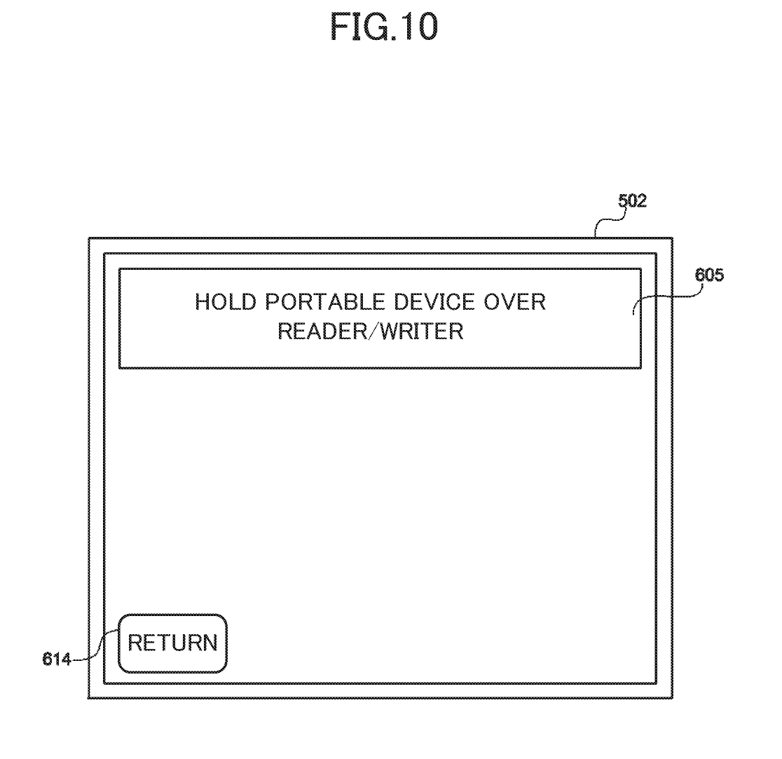

Subsequently, the self-service fuel providing machine 501 prompts the person subjected to the providing to hold the portable device 201 over the reader/writer 503. FIG. 10 is a display example of a screen for guiding the person subjected to the providing to place the portable device within the communicable range. According to the example illustrated in this figure, various messages for the person subjected to the providing are displayed on the message display field 605.

Before the portable device 201 enters the communicable range with the reader/writer 503, a message such as “HOLD PORTABLE DEVICE OVER READER/WRITER” is displayed on the message display field 605. This figure is a display example of this stage.

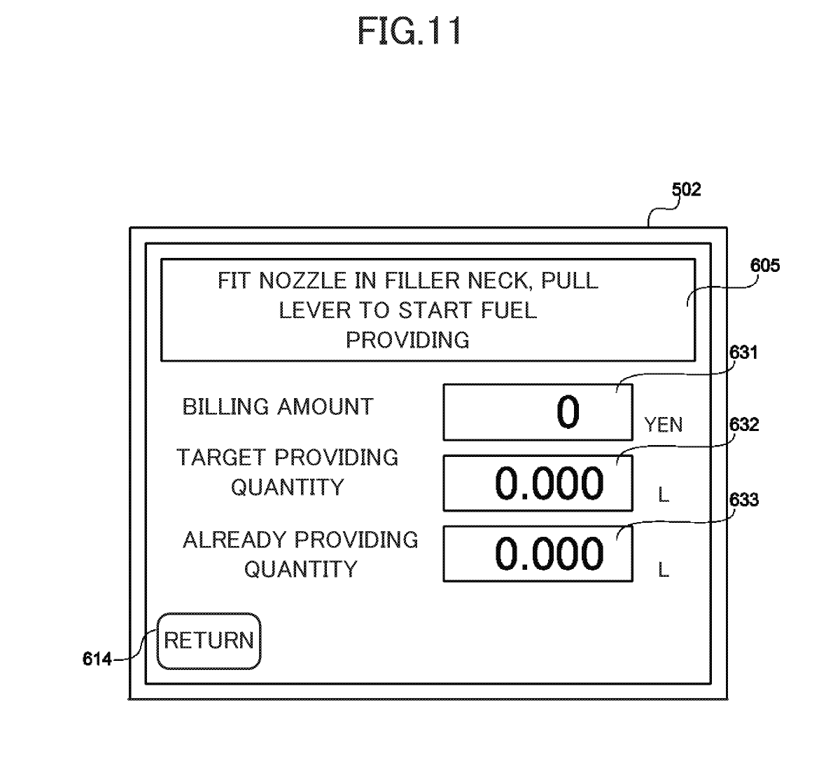

Conversely, when the person subjected to the providing causes the holder 551 or the like to hold the portable device 201 as appropriate, the portable device 201 enters the communicable range with the reader/writer 503, and the communication therebetween is established (step S303), the display by the message display field 605 changes. FIG. 11 is a display example of a screen for guiding the person subjected to the providing to fit the nozzle in the filler neck, to pull the lever, and to start the providing of gasoline. According to the example illustrated in this figure, a message such as “FIT NOZZLE IN FILLER NECK, PULL LEVER TO START FUEL PROVIDING” is displayed on the message display field 605.

The person subjected to the providing who has viewed this message takes out the tank cap from the vehicle, takes out the nozzle 507 for the desired kind of fuel from the main unit of the self-service fuel providing machine 501, fits the nozzle in the filler neck of the vehicle, and pulls the lever of the nozzle 507. This starts the initial sequences (steps S304-S322) of requesting the decrease of the remaining value to the portable device 201, increasing the target providing quantity, determining the end condition, and detecting an occurrence of the end event are executed, and thus the fuel providing starts.

Whether or not the portable device 201 enters the communicable range with the reader/writer 503 may be detected by a piezoelectric sensor or an electrostatic sensor, and the process may progress to the status in 11 upon the detection result. In this case, after the lever of the nozzle 507 is pulled, the communication between the portable device 201 and the reader/writer 503 is established.

Once the fuel providing starts, while the lever of the nozzle 507 is being pulled, the sequences (steps S304-S322) of requesting the decrease of the remaining value to the portable device 201, increasing the target providing quantity, determining the end condition, and detecting an occurrence of the end event are repeatedly executed.

Note that according to this embodiment, the initial billing is not executed when the portable device 201 is simply held over the reader/writer 503, but the billing starts when the nozzle 507 is taken out from the main unit of the self-service fuel providing machine 501, and the lever is pulled. However, the initial billing may be executed when the portable device 201 is simply held over the reader/writer 503.

When, without the portable device 201 being held over the reader/writer 503, the nozzle 507 is taken out from the main unit of the self-service fuel providing machine 501, the nozzle is fitted in the filler neck, and the lever of the nozzle 507 is pulled, no billing is executed. Accordingly, no gasoline or the like is provided from the nozzle 507.

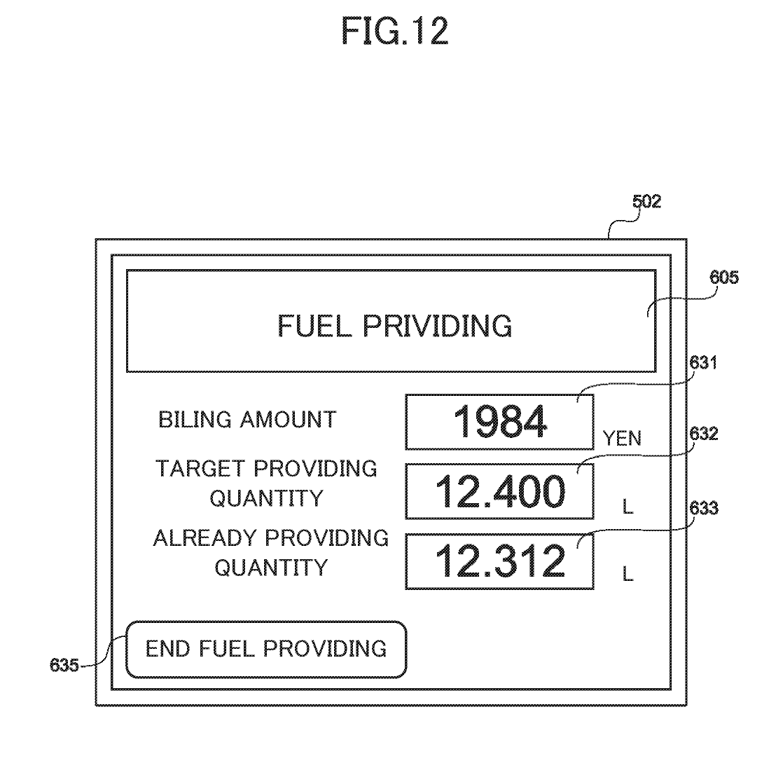

While the gasoline is being provided, the touch screen of the operation panel 502 displays information on the providing status. FIG. 12 is a display example of the screen for letting the person subjected to the providing to know the providing status of the trade object. According to the example illustrated in this figure, the numerical number of the paid value indicating, for the person subjected to the providing, how much the electronic money is decreased from the start of the trade and up to the present time is displayed on a billing amount display field 631, the target providing quantity relative to the numerical number of the paid value is displayed on a target quantity display field 632, and the already provided quantity of gasoline from the nozzle 507 to the vehicle is displayed on an already-provided-quantity display field 633. In addition, various messages are displayed on the message display field 605. In this figure, the lever of the nozzle 507 that is being pulled by the user is detected and a message “FUEL PROVIDING” is displayed, but while the lever is being returned, a message such as “PULL LEVER TO START FUEL PROVIDING” is displayed.

In this embodiment, an example condition in which gasoline is 160 YEN per a liter, the minimum price value is 16 YEN, and the minimum providing quantity is 0.1 L is expected and illustrated. Since the billing amount is 1984 YEN, what is apparent from this figure is that the billing up to the 124⁻th billing has been successful. In addition, the target providing quantity is 12.4 L in accordance with the billing amount.

Still further, when the user touches an end button 635 displayed as “END FUEL PROVIDING” on the touch screen of the operation panel 502, the end condition is satisfied (step S341: YES), and the trade will end after the gasoline or the like is provided up to the target providing quantity (step S323). That is, even if the person subjected to the providing keeps pulling the lever of the nozzle 507 subsequent to this step, the billing is not made any more, and the trade will end after the gasoline is provided up to the displayed target providing quantity.

When quitting the fuel providing at the present already provided quantity without filling the gasoline up to the target providing quantity, the person subjected to the providing may simply detach the nozzle 507 from the vehicle and return the nozzle to the main unit of the self-service fuel providing machine 501.

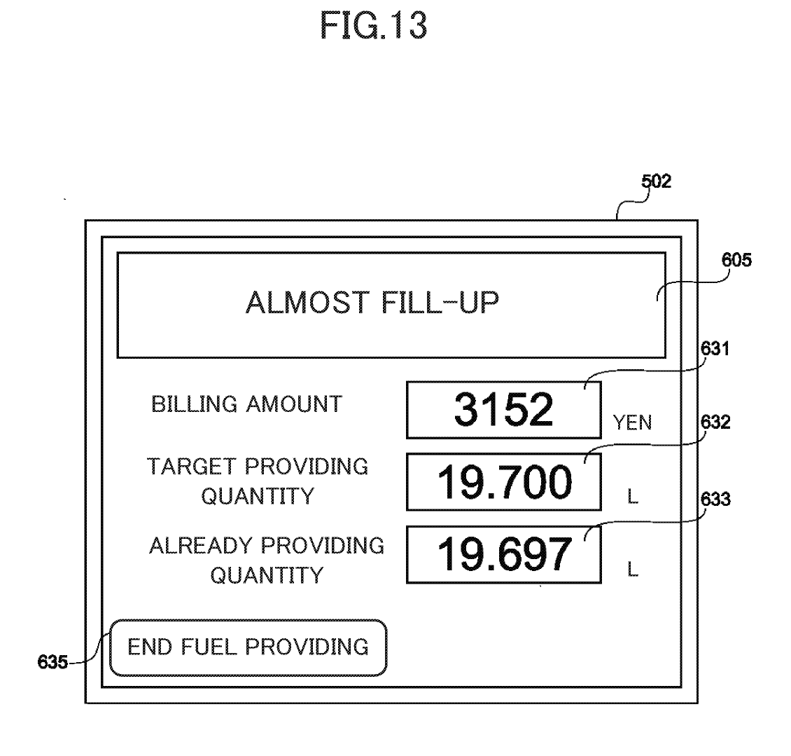

While the gasoline is being provided, the automatic stop condition being satisfied may be detected at the nozzle 507. FIG. 13 is a display example of a screen for letting the person subjected to the providing to know a detection that the next providing of the trade object is not ready. According to the example illustrated in this figure, the 197-th billing has completed, the billing amount has become 3152 YEN, the target providing quantity has been 19.7 L and the total providing quantity of 19.697 L that has reached the level Z is detected. In this case, a message “ALMOST FULL” is displayed on the message display field 605. In the case of the hands-free fuel providing, the locking mechanism that keeps the lever of the nozzle 507 being pulled is canceled, and the lever is returned.

When the automatic stop condition that has been satisfied is detected, the self-service fuel providing machine 501 becomes a condition in which the lever of the nozzle 507 cannot be fully pulled, or a condition in which gasoline is not provided even if the lever is fully pulled. At this time, when the person subjected to the providing adjusts the position of the nozzle 507 at the filler neck, air in the tank may be discharged, and the automatic stop condition that has been satisfied may be canceled. That is, this is a situation in which once the end condition is satisfied but this end condition is canceled later. In this case, the person subjected to the providing is allowed to fully pull the lever again, and the control flow returns to the sequences of making a request to the portable device 201 and increasing the target providing quantity. Hence, the display by the operation panel 502 returns to FIG. 12, and the subsequent fuel providing is enabled at the maximum flow rate. In addition, when the self-service fuel providing machine 501 is compatible with the hands-free fuel providing, the fuel providing in this manner is enabled.

In addition, when desiring to end the trade upon filling of gasoline up to the target providing quantity, the person subjected to the providing may simply operate the end button 635. This enables the person subjected to the providing to pull the lever gently so as to fill the gasoline up to the paid amount at the little flow rate. This is because the automatic stop condition is satisfied with the interior of the tank having a margin quantity to some level. The details of the level of the quantity of gasoline in the tank relating to the automatic stop will be explained later.

Note that while the automatic stop condition that has been satisfied is being detected, the end condition is also satisfied, and thus the further billing is not made any more. Hence, the person subjected to the providing is enabled to pull the lever gently and to provide the gasoline up to the target providing quantity without operating the end button 635.

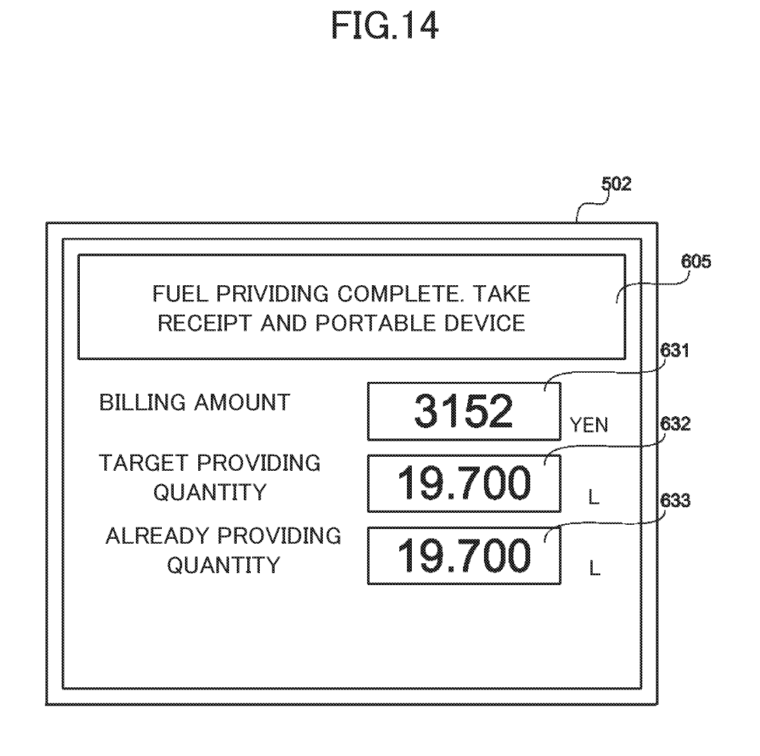

When the fuel providing completes, the trade completes. FIG. 14 is a display example of a screen for letting the person subjected to the providing to know the completion of the trade. In this figure, a message “FUEL PROVIDING COMPLETE. TAKE RECEIPT AND PORTABLE DEVICE is displayed on the message display field 605, and the end button 635 disappears.

According to this display example, since the gasoline has been provided up to the quantity equivalent to the billed total compensation and the trade is ended, the target providing quantity is consistent with the already provided quantity. When the event that should end the fuel providing occurs and the fuel providing is terminated, the target providing quantity may be inconsistent with the already provided quantity, but the refund is unnecessary when the person subjected to the providing terminates the fuel providing by the person's will. When the fuel providing is terminated due to, for example, an error inherent to the self-service fuel providing machine, the refund may be made at the store.

(Fill-Up Detection)

According to this embodiment, a different level from those of conventional self-service fuel providing machines is set up for the detection of the fill-up. The simplest detection sensor for fill-up determines as “fill-up” when the pressure at the nozzle tip keenly increases. Typically, a determination on the “fill-up” is made on the basis of the temperature and the pressure in the tank, the providing flow rate, the pressure in the nozzle for fuel providing, and the like. In addition to those typical conditions, due to unevenness of the ground, the determination on the gasoline quantity contains an error. Hence, according to conventional self-service fuel providing machines, in order to suppress a leakage from the tank at the time of fuel providing, in view of the error, a “level Y corresponding to the gasoline quantity slightly less than that of level X” is detected instead of the “level X at which gasoline or the like leaks when provided more”, and the level Y is defined as “fill-up”. In addition, when a determination that the gasoline quantity reaches the level Y is made, in the case of the hands-free fuel providing, this automatic operation is canceled, and the lever of the nozzle 507 cannot be fully pulled or the gasoline is not provided even if the lever is fully pulled. According to conventional self-service fuel providing machines, when the lever is slightly pulled after the level Y is detected, a little quantity of gasoline can be further provided.

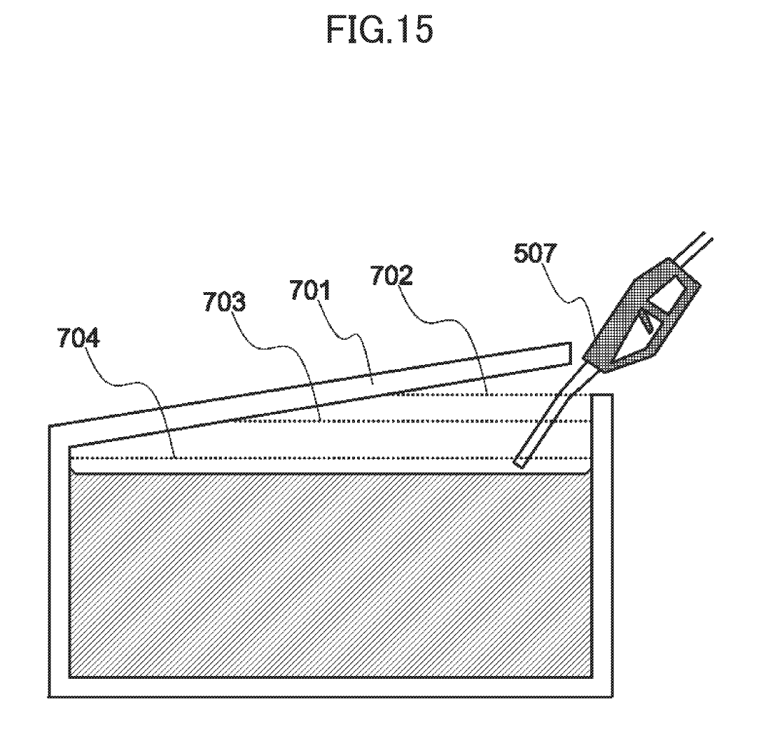

Conversely, according to this embodiment, the level Z that has a further less gasoline quantity than those of the level X and the level Y is set. FIG. 15 is an explanatory diagram of the gasoline quantity level in the tank. In this figure, in a tank 701, the level X (702) at which a leakage occurs, the level Y (703) that has a little gasoline quantity than that of the level X (702), and the level Z (704) that has a further little gasoline quantity than that of the level Y (703) are indicated.

In this embodiment, when a sensor detects that the gasoline quantity reaches the level Z (704), the automatic stop condition is satisfied. As explained above, when the gasoline of G mL is provided relative to the price value of V per a request, and when the requests from the initial time to the n-th time are successful, the total value decreased by the billing becomes n×V, and the target providing quantity becomes n×G mL.

Next, the determination on the (n+1)-th compensation, the transmission of the request, the reception of the response, and the update of the target providing quantity are executed after the providing of (n−1)-th time completes and until the providing of n-th time completes after the providing of n-th time starts subsequent to the last providing, that is, while the already provided total quantity is between (n−1)×G milliliter and n×G milliliter.

At the (n+1)-th determination, when a determination that the gasoline quantity has not reached the level Z (704) yet is made, the (n+1)-th billing will be made, and thus the target providing quantity becomes (n+1)×G Ml. In addition, the already provided quantity at the time of (n+1)-th determination is between (n−1)×G mL and n x G mL, the gasoline of between 1×G mL and 2×G mL is to be provided after the determination.

Hence, when the margin quantity that is a difference between the gasoline quantity of the level Z and that of the level Y is set to be at least the minimum providing quantity that is G mL, a leakage from the tank is preventable at the similar risk occurrence rate to that of conventional technologies. In addition, when the margin quantity is set to be equal to or greater than 2×G mL (equal to or greater than twice as much as the minimum providing quantity), as long as, for example, the sensor is not defective, a leakage from the tank is completely preventable.

(Unsuccessful Communication and Shortage of Balance)

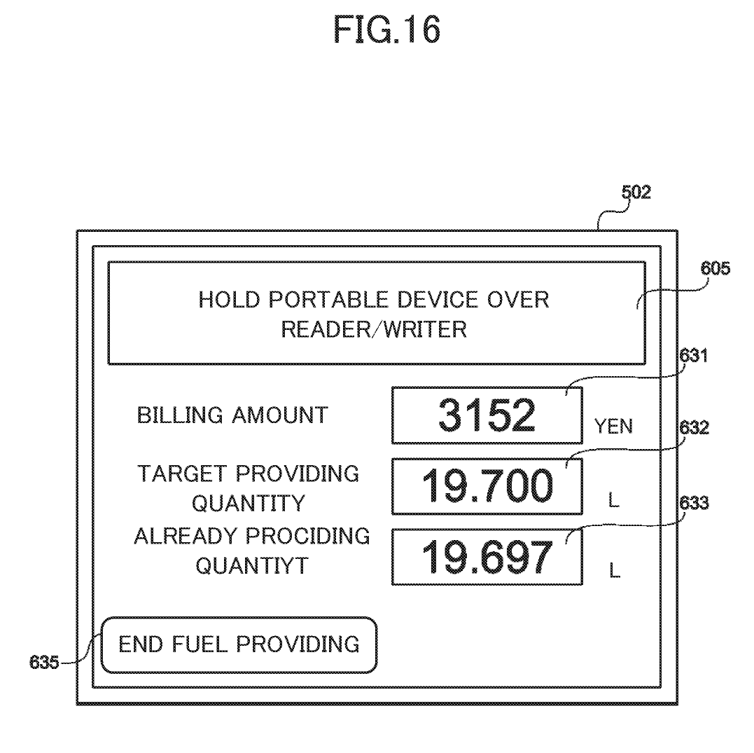

During the fuel providing, the communication between the portable device 201 and the reader/writer 503 may become unsuccessful. FIG. 16 is a display example of a screen for letting the person subjected to the providing to know an occurrence of the communication error with the portable device. In this figure, a message “HOLD PORTABLE DEVICE OVER READER/WRITER” is displayed on the message display field 605.

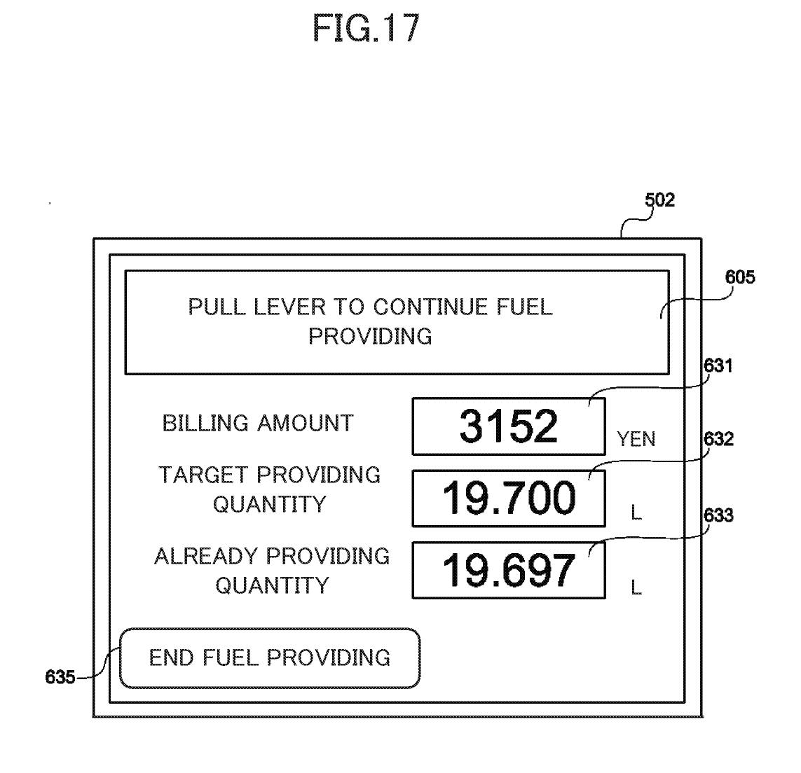

Subsequently, when the user corrects the position of the portable device and the communication is re-established, the fuel providing is enabled in sequence. FIG. 17 is a display example of a screen for letting the person subjected to the providing to know that the error in the providing status is addressed. In this figure, a message “PULL LEVER TO CONTINUE FUEL PROVIDING” is displayed on the message display field 605.

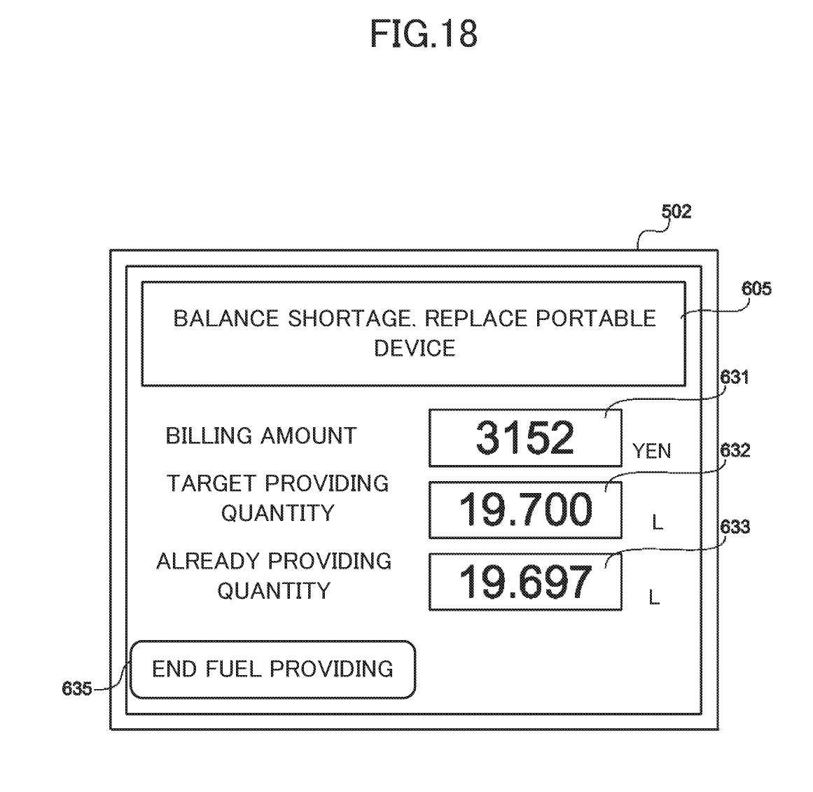

In addition, during the fuel providing, the remaining value in the portable device 201 may become smaller than the minimum price value, and the execution of the decrease command may become unsuccessful. FIG. 18 is a display example of a screen for letting the person subjected to the providing to know the shortage of the remaining value in the portable device. In this figure, a message “BALANCE SHORTAGE. REPLACE PORTABLE DEVICE” is displayed on the message display field 605.

When the person subjected to the providing attempts to replace the portable device, once the communication is interrupted. Hence, the display by the touch screen of the operation panel 502 changes to the one illustrated in FIG. 16. The subsequent process is the same as the one explained above.

Even if the communication is being unsuccessful and the shortage of balance is occurring, the fuel providing is enabled up to the target providing quantity. Hence, when the person subjected to the providing operates the end button 635 and pulls the lever of the nozzle, or operates the end button 635 while pulling the lever of the nozzle, the trade will end upon filling of the gasoline or the like up to the target providing quantity.

According to this embodiment, the fuel providing or the like can be carried out as appropriate by utilizing the electronic money.

### Fifth Embodiment

In the above embodiments, although the minimum price value and the minimum providing quantity are constant between the start of the trade and the end thereof, those value and quantity may be made variable.

When, for example, the minimum price value is set to 15 YEN to have a large flow rate of fuel providing from the start of the fuel providing and up to 10 L, and then the minimum price value is set to 10 YEN so as to allow the much fuel providing as possible, the necessary time for the providing can be reduced in comparison with the case in which the minimum price value is constant that is 10 YEN, and the increase of the total providing quantity is expectable in comparison with the case in which the minimum price value is constant that is 15 YEN.

### Sixth Embodiment

This embodiment is a suitable form of the above embodiments, and the present disclosure is applied to a copying service that utilizes the ADF. In order to facilitate understanding, the explanation for the common feature and the already explained feature will be omitted as appropriate.

In the copying service, the person subjected to the providing is capable of copying the documents without knowing the total number of documents. In this case, the total number of documents becomes apparent upon completion of the total documents, and the amount of payment for the copying service is settled.

According to this embodiment, when the copying of documents starts, the following processes are repeated:

(1) a document is loaded to the scanning position from the ADF;

(2) the loaded document is scanned and the copy is printed; and

(3) the copied document is ejected from the scanning position.

In this case, the ejection of the copied document and the loading of the next document may be executed simultaneously.

In this embodiment, a material that is a document is utilized and the service is provided with the minimum providing quantity that is a copy of a document. Hence, “while the copying of documents is being executed, that is, until the start of the ejection of the document after the loading of the document completes”, “a determination on whether or not the next document is left in the ADF is made, and the billing for the next document copying is made when the next document is left” are repeatedly executable That is, while the service to the present document is being provided, whether or not the billing to the next document is possible is determined, and the billing is made when necessary. This is a distinguishable feature of the present disclosure from the related art.

According to this embodiment, a sequential copying is enabled without an interruption as much as possible, reducing the working time.

As explained above, a management device according to the present disclosure includes a communicator that communicates with a portable device entering a communicable range, and manages a trade in which a total provided quantity of a trade object provided from a start of the trade and an end thereof is settled upon the end of the trade. The management device includes:

a requestor that transmits, to the portable device via the communicator, a request of decreasing a minimum price value corresponding to a minimum trade unit of the trade object from a remaining value associated with the portable device;

a controller that performs a control of providing the trade object by the minimum trade unit when a response to the request received from the portable device via the communicator indicates that the request is successful; and a determiner that determines whether or not a next providing to the providing of the trade object by the minimum trade unit relative to the response indicating the success is possible on a basis of a providing status of the trade object, in which:

when a determination that the next providing is possible is made, a next request of further decreasing the minimum price value from the remaining value associated with the portable device is transmitted to the portable device via the communicator; and when a determination that the next providing is not ready is made, the trade is ended without a transmission of the next request.

In the management device according to the present disclosure, the determination on whether or not the next providing is possible is made after the start of the providing of the trade object by the minimum trade unit relative to the response indicating the success, and prior to a completion of the providing, and the next request is transmitted prior to the completion of the providing of the trade object by the minimum trade unit relative to the response indicating the success.

In the management device according to the present disclosure, when the determination that the next providing is not ready, the trade is ended upon completion of the providing of the trade object by the minimum trade unit relative to the response indicating the success.

In the management device according to the present disclosure, whether or not the next providing is possible is made after the start of the providing of the trade object by the minimum trade quantity relative to the response indicating the success and prior to the completion of the providing on the basis of:

(a) a sum of the quantity of the trade object possessed by the person subjected to the providing of the trade object before the start of the providing of the trade object by the minimum trade quantity relative to the response indicating the success and the double of the minimum trade unit; and

(b) whether or not the sum is equal to or smaller than the maximum quantity that can be possessed by the person subjected to the providing.

In the management device according to the present disclosure,

the remaining value associated with the portable device is obtained from the portable device via the communicator prior to the transmission of the request, and

the transmission of the request is not made, and the trade is ended when the obtained remaining value is less than the minimum price value.

In the management device of the present disclosure, prior to the end of the trade due to the obtained remaining value that is less than the minimum price value, an inquiry on whether or not to end the trade is given to a person subjected to the providing of the trade object, and when the person subjected to the providing gives a reply not to end the trade, the request is transmitted to another portable device that is entering the communicable range.

In the management device according to the present disclosure, when the response to the request is not received within a predetermined threshold time period after the transmission of the request, the trade object by the minimum trade unit is not provided, and the trade is ended.

In the management device according to the present disclosure, prior to the end of the trade due to the response unreceived, an inquiry on whether or not to end the trade is given to a person subjected to the providing of the trade object, and when the person subjected to the providing gives a reply not to end the trade, the request is transmitted again.

In the management device according to the present disclosure,

the request to be transmitted again is transmitted to the portable device or another portable device entering the communicable range.

In the management device according to the present disclosure, the trade is ended by the controller upon completion of the providing of the trade object by the minimum trade unit relative to the response indicating the success, on a basis of a setting given by a person subjected to the providing of the trade object prior to the start of the trade, or an operation given by the person subjected to the providing after the start of the trade.

In the management device according to the present disclosure,

the providing of the trade object is carried out using a material prepared by the person subjected to the providing, and

whether or not the next providing is possible is determined after the start of the providing by the minimum providing quantity relative to the response indicating the success and prior to the completion of the providing, and on the basis of whether or not the available material is left.

In the management device according to the present disclosure,

when the response received relative to the request indicates that the request is unsuccessful, the controller ends the trade without providing the trade object by the minimum trade unit relative to the response indicating the unsuccessful request.

In the management device according to the present disclosure,

whether or not to end the trade is inquired to the person subjected to the providing of the trade object prior to the end of the trade due to the response that indicates the unsuccessful request, and when a reply not to end the trade is given by the person subjected to the providing, the request is transmitted to another portable device entering the communicable range.

In the management device according to the present disclosure,

the already provided quantity of the trade object provided after the start of the trade is measured in a predetermined measurement unit, and

the providing of the trade object by the minimum trade unit relative to the response indicating the success completes when:

the measured already provided quantity reaches a target providing quantity that is the minimum providing quantity multiplied by the total number of successful requests after the start of the trade.

In the management device according to the present disclosure,

when the portable device is held over the communicator, the portable device enters the communicable range.

In addition, a management device according to the present disclosure includes:

a data exchanger that exchanges data with a portable device when the portable device enters an exchangeable range; and

a controller that controls a trade of a trade object in which a quantity of trade is not settled before a start of the trade although the trade is to be made in accordance with a trade request from a user,

in which:

the controller includes:

a value changer that transmits, to the portable device via the data exchanger, a value change signal of decreasing a price value corresponding to a minimum trade quantity of the trade object from a remaining value associated with the portable device;

a providing processor that executes a process of providing the trade object by the minimum trade quantity to the user when a response signal transmitted from the portable device in response to the value change signal transmitted from the value changer and indicating a change in the remaining value is received by the data exchanger;

a providing possibility determiner that determines whether or not a next providing of the trade object by the minimum trade quantity is possible on a basis of a providing status of the trade object; and

an ending processor that executes a process of ending the trade on a basis of a setting given by the user; and

the value changer transmits, to the portable device via the data exchanger, the value change signal in response to a completion of the providing of the trade object by the minimum trade quantity to the user when the providing possibility determiner determines that the next providing is possible, and restricts a transmission of the value change signal when the providing possibility determiner determines that the next providing is not ready.

Still further, a management method according to the present disclosure is executed by a management device including a communicator that communicates with a portable device entering a communicable range, and managing a trade in which a total provided quantity of a trade object provided from a start of the trade and an end thereof is settled upon the end of the trade. The management method includes:

a requesting step of causing the management device to transmit, to the portable device via the communicator, a request of decreasing a minimum price value corresponding to a minimum trade unit of the trade object from a remaining value associated with the portable device;

a control step of performing a control on the management device to provide the trade object by the minimum trade unit when a response to the request received from the portable device via the communicator indicates that the request is successful; and

a determining step of causing the management device to determine whether or not a next providing to the providing of the trade object by the minimum trade unit relative to the response indicating the success is possible on a basis of a providing status of the trade object,

in which:

when a determination that the next providing is possible is made, a next request of further decreasing the minimum price value from the remaining value associated with the portable device is transmitted to the portable device via the communicator; and

when a determination that the next providing is not ready is made, the trade is ended without a transmission of the next request.

A program according to the present disclosure causes a computer including a communicator that communicates with a portable device entering a communicable range to manage a trade in which a total provided quantity of a trade object provided from a start of the trade and an end thereof is settled upon the end of the trade. The program further causes the computer to function as:

a requestor that transmits, to the portable device via the communicator, a request of decreasing a minimum price value corresponding to a minimum trade unit of the trade object from a remaining value associated with the portable device;

a controller that performs a control of providing the trade object by the minimum trade unit when a response to the request received from the portable device via the communicator indicates that the request is successful; and

a determiner that determines whether or not a next providing to the providing of the trade object by the minimum trade unit relative to the response indicating the success is possible on a basis of a providing status of the trade object,

in which:

when a determination that the next providing is possible is made, a next request of further decreasing the minimum price value from the remaining value associated with the portable device is transmitted to the portable device via the communicator; and

when a determination that the next providing is not ready is made, the trade is ended without a transmission of the next request.

The above program may be recorded in a non transitory (non-transitory) computer-readable information recording medium, such as a compact disc, a flexible disk, a hard disk, a magneto-optical disk, a digital video disc, a magnetic tape, a Read Only Memory (ROM), an Electrically Erasable Programmable ROM (EEPROM), a flash memory, or a semiconductor memory. This information recording medium may be independently distributed and sold from a computer.

In general, a computer reads the program recorded in the non transitory (non-transitory) information recording medium in a Random Access Memory (RAM) that is a temporary memory device, and causes a Central Processing Unit (CPU) to execute instructions contained in the read program. According to, however, an architecture in which a ROM and a RAM are mapped in a memory space for the execution, the instructions contained in the program stored in the ROM are directly read and executed by the CPU.

In addition, the above program may be distributed and sold from a server device or the like to a terminal device or the like via a transitory (transitory) transmission medium like a computer communication network independently from the computer that executes the program.

### INDUSTRIAL APPLICABILITY

According to the present disclosure, suitable management device and management method for managing trades in which the total provided quantity of a trade object to be provided from the start of the trade and until the end thereof is settled, and the remaining value associated with a portable device is decreased from the start of the trade and until the end thereof as a compensation for the providing by what corresponds to the total price value to the total provided quantity, and a program for accomplishing those by a computer.

### REFERENCE SIGNS LIST

101 Management device
102 Communicator
103 Requestor
104 Controller
105 Determiner
201 Portable device
202 Providing device
203 External storage device
204 Electronic money server
501 Self-service fuel providing machine
502 Operation panel
503 Reader/writer
504 Cash loading slot
505 Card loading slot
506 Printer
507 Nozzle
508 Camera
551 Holder
552 Front surface of self-service fuel providing machine
601a, 601b, 601c, 601d Payment method button
605 Message display field
611a, 611b, 611c Fuel kind check box
612a, 612b, 612c, 612d, 612e Upper limit quantity button
613a, 613b, 613c, 613d Upper limit amount button
614 Return button
631 Billing amount display field
632 Target quantity display field
633 Already provided quantity display field
635 End button
701 Tank
702 Level X
703 Level Y
704 Level Z

1. A management device comprising a communicator that communicates with a portable device entering a communicable range, and managing a trade in which a total provided quantity of a trade object provided from a start of the trade and an end thereof is settled upon the end of the trade, the management device comprising:
a requestor that transmits, to the portable device via the communicator, a request of decreasing a minimum price value corresponding to a minimum trade unit of the trade object from a remaining value associated with the portable device;
a controller that performs a control of providing the trade object by the minimum trade unit when a response to the request received from the portable device via the communicator indicates that the request is successful; and
a determiner that determines whether or not a next providing to the providing of the trade object by the minimum trade unit relative to the response indicating the success is possible on a basis of a providing status of the trade object,
wherein:
when a determination that the next providing is possible is made, a next request of further decreasing the minimum price value from the remaining value associated with the portable device is transmitted to the portable device via the communicator; and
when a determination that the next providing is not ready is made, the trade is ended without a transmission of the next request.

2. The management device according to claim 1, wherein:
the determination on whether or not the next providing is possible is made after the start of the providing of the trade object by the minimum trade unit relative to the response indicating the success, and prior to a completion of the providing; and
the next request is transmitted prior to the completion of the providing of the trade object by the minimum trade unit relative to the response indicating the success.

3. The management device according to claim 2, wherein when the determination that the next providing is not ready, the trade is ended upon completion of the providing of the trade object by the minimum trade unit relative to the response indicating the success.

4. The management device according to claim 1, wherein:
the remaining value associated with the portable device is obtained from the portable device via the communicator prior to the transmission of the request; and
the transmission of the request is not made, and the trade is ended when the obtained remaining value is less than the minimum price value.

5. The management device according to claim 4, wherein, prior to the end of the trade due to the obtained remaining value that is less than the minimum price value, an inquiry on whether or not to end the trade is given to a person subjected to the providing of the trade object, and when the person subjected to the providing gives a reply not to end the trade, the request is transmitted to another portable device that is entering the communicable range.

6. The management device according to claim 1, wherein when the response to the request is not received within a predetermined threshold time period after the transmission of the request, the trade object by the minimum trade unit is not provided, and the trade is ended.

7. The management device according to claim 6, wherein, prior to the end of the trade due to the response unreceived, an inquiry on whether or not to end the trade is given to a person subjected to the providing of the trade object, and when the person subjected to the providing gives a reply not to end the trade, the request is transmitted again.

8. The management device according to claim 1, wherein the trade is ended by the controller upon completion of the providing of the trade object by the minimum trade unit relative to the response indicating the success, on a basis of a setting given by a person subjected to the providing of the trade object prior to the start of the trade, or an operation given by the person subjected to the providing after the start of the trade.

9. The management device according to claim 1, wherein when the portable device is held over the communicator, the portable device enters the communicable range.

10. A management method executed by a management device comprising a communicator that communicates with a portable device entering a communicable range, and managing a trade in which a total provided quantity of a trade object provided from a start of the trade and an end thereof is settled upon the end of the trade, the management method comprising:
a requesting step of causing the management device to transmit, to the portable device via the communicator, a request of decreasing a minimum price value corresponding to a minimum trade unit of the trade object from a remaining value associated with the portable device;
a control step of performing a control on the management device to provide the trade object by the minimum trade unit when a response to the request received from the portable device via the communicator indicates that the request is successful; and
a determining step of causing the management device to determine whether or not a next providing to the providing of the trade object by the minimum trade unit relative to the response indicating the success is possible on a basis of a providing status of the trade object,
wherein:
when a determination that the next providing is possible is made, a next request of further decreasing the minimum price value from the remaining value associated with the portable device is transmitted to the portable device via the communicator; and
when a determination that the next providing is not ready is made, the trade is ended without a transmission of the next request.

11. (canceled)

12. A management device comprising:
a data exchanger that exchanges data with a portable device when the portable device enters an exchangeable range; and
a controller that controls a trade of a trade object in which a quantity of trade is not settled before a start of the trade although the trade is to be made in accordance with a trade request from a user,
wherein:
the controller comprises:
a value changer that transmits, to the portable device via the data exchanger, a value change signal of decreasing a price value corresponding to a minimum trade quantity of the trade object from a remaining value associated with the portable device;
a providing processor that executes a process of providing the trade object by the minimum trade quantity to the user when a response signal transmitted from the portable device in response to the value change signal transmitted from the value changer and indicating a change in the remaining value is received by the data exchanger;
a providing possibility determiner that determines whether or not a next providing of the trade object by the minimum trade quantity is possible on a basis of a providing status of the trade object; and
an ending processor that executes a process of ending the trade on a basis of a setting given by the user; and
the value changer transmits, to the portable device via the data exchanger, the value change signal in response to a completion of the providing of the trade object by the minimum trade quantity to the user when the providing possibility determiner determines that the next providing is possible, and restricts a transmission of the value change signal when the providing possibility determiner determines that the next providing is not ready.
